(19) United States
(12) Patent Application Publication
(10) Pub. No.: US 2026/0129602 A1
(43) Pub. Date: May 7, 2026

(54) DYNAMIC COVERAGE OPTIMIZATION FOR NETWORK ENERGY SAVINGS

(71) Applicant: QUALCOMM Incorporated, San Diego, CA (US)

(72) Inventors: Shuvam CHAKRABORTY, Albany, NY (US); Navid ABEDINI, Basking Ridge, NJ (US); Wenjun LI, Basking Ridge, NJ (US); Naeem AKL, Bridgewater, NJ (US)

(21) Appl. No.: 18/939,484

(22) Filed: Nov. 6, 2024

(51) Int. Cl. H04W 64/00; H04W 16/28; H04W 56/00

(52) U.S. Cl. CPC H04W 64/00; H04W 16/28; H04W 56/0015

(57) ABSTRACT

Dynamic coverage optimization for network energy savings is described. An apparatus is configured to receive or retrieve first information indicative of a coverage region. The coverage region has a common definition common for both the first network device and a set of second network devices that is independent of cells, beams, and/or SSBs of the network devices. The apparatus is also configured to provide, to the set of second network devices, second information associated with a coverage state for the coverage region having the common definition.

### TECHNICAL FIELD

The present disclosure relates generally to communication systems, and more particularly, to wireless systems utilizing coverage configurations.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a network node, a network entity, a user equipment (UE), a core network function, and/or the like. The apparatus is configured to receive or retrieve first information indicative of a coverage region, where the coverage region has a common definition common for both the first network device and a set of second network devices. The apparatus is also configured to provide, to the set of second network devices, second information associated with a coverage state for the coverage region having the common definition.

In the aspect, the method includes receiving or retrieving first information indicative of a coverage region, where the coverage region has a common definition common for both the first network device and a set of second network devices. The method also includes providing, to the set of second network devices, second information associated with a coverage state for the coverage region having the common definition.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of coverage regions, for network nodes, defined by cells, beams, or SSBs of the network nodes.

FIG. 5 is a call flow diagram for wireless communications, in accordance with various aspects of the present disclosure.

FIG. 6 is a diagram illustrating coverage regions with common definitions, in accordance with various aspects of the present disclosure.

FIG. 7 is a diagram illustrating dynamic optimizations for coverage regions with common definitions, in accordance with various aspects of the present disclosure.

FIG. 8 is a diagram illustrating information exchange for dynamic optimizations of coverage states and coverage regions with common definitions, in accordance with various aspects of the present disclosure.

FIG. 9 is a diagram illustrating information exchange for dynamic optimizations of coverage states and dynamic coverage regions with common definitions, in accordance with various aspects of the present disclosure.

FIG. 10 is a diagram illustrating information exchange for dynamic optimizations of coverage states and dynamic coverage regions with common definitions, in accordance with various aspects of the present disclosure.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

FIG. 14 is a diagram illustrating an example of a hardware implementation for an example network entity.

### DETAILED DESCRIPTION

Wireless communication networks may be designed to support communications between network nodes (e.g., base stations, gNBs, etc.), network entities/functions (e.g., in a core network), and UEs. For instance, network nodes may communicate information between with each other for coverage configurations/reconfigurations, such as information associated with cells and/or beams of such cells, abstract coverage state values, etc. Such communication enables the network nodes to change their coverage states in an informed manner. In such scenarios, a network node may be assumed to keep a history of measurements and/or configuration settings for coverage of another network node and to utilize such information for future operations, such as requesting cell/beam activations from the other network node. In some scenarios, a network node may adopt within or change into different coverage configuration based on different requirements, such as current load, capacity etc. Such configurations may include inactive or different active states based on demand, and may attempt to utilize the configuration changes for improved energy efficiency, network energy savings, improved coverage (e.g., quality of service (QoS)), mobility robustness management, etc. For example, a network node that has changed its configuration may share a node configuration update message that includes impacted cell identifiers, their coverage state indicators, impacted synchronized signal block (SSB) indices, and/or corresponding coverage state indicators (e.g., as mapped into integers defining inactive and different active states). In a related context, there are also procedures for exchanging cell and beam activation requests across network nodes.

Aspects presented herein provide frameworks to determine and indicate coverage in a more efficient manner. As an example, without the coordination presented herein, a first network node at time T1 may have had a first coverage configuration and may have notified a second network node about its set of active cells and beams, as well as associated coverage states (e.g., where the coverage state is a 4-bit or 6-bit logical index). The first network node, at time T2, may have changed to a second coverage state configuration (e.g., and again notified the second network node about its updated set of active cells and beams, and associated coverage states). In some cases, for energy savings, the second network node may have deactivated some of its cells and/or beams. At time T3, the second network node may determine it has load issue in a part of its coverage region (e.g., due to the adopted second coverage configuration of the first network node), and may request the first network node to activate some of its cells and beams (e.g., SSBs). Yet, for this to interaction to be utilized, the second network node should have stored/remembered which cells and SSBs of the first network node, at an earlier time (e.g., at T1), were helping with load balancing for that part of its coverage region, and use those cells and beams of the first network node as a reference for making its requests. Such operations are complicated for network nodes to keep such a memory and analysis of mapping between configuration (e.g., cells/beams) of other network nodes and a network node's own coverage regions. Moreover, the first network node may change its beamforming codebook used for its SSBs, but using an SSB index (such as when it is deactivated and no longer available) to refer to a coverage region generally does not properly work.

Various aspects relate generally to coverage configurations. Some aspects more specifically relate to dynamic coverage optimization for network energy savings (NES). In some examples, network devices may be configured with a coverage region(s) having a common definition that is common therebetween and defined independently of beams, SSBs, transmission reception points (TRPs), and cells of network devices. In some examples, a given coverage region may be made up of a number of areas, associated with unique area identifiers, configured as a set of physical areas, a set of geographic areas, and/or a set of digital area representations. In some examples, coverage states may be provided for a coverage region and/or for one or more coverage areas. In some examples, coverage states may be indicated based on coverage state indices (e.g., a set of common logical indices). In some examples, a coverage indication framework may be utilized between network devices to facilitate communication of coverage state information based on the common coverage region/areas.

Particular aspects of the subject matter described in this disclosure can be implemented to realize one or more of the following potential advantages. In some examples, by utilizing commonly- or globally-defined coverage regions or zones for network devices, rather than device-specific references (e.g., such as beams/SSBs, cells, and/or the like) to define coverage, the described techniques can be used to increase coverage efficiency with the coverage regions. In some examples, by utilizing a coverage indication framework based on the commonly-defined coverage regions, the described techniques can be used to improve communications associated with the configurations/reconfigurations for the coverage regions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

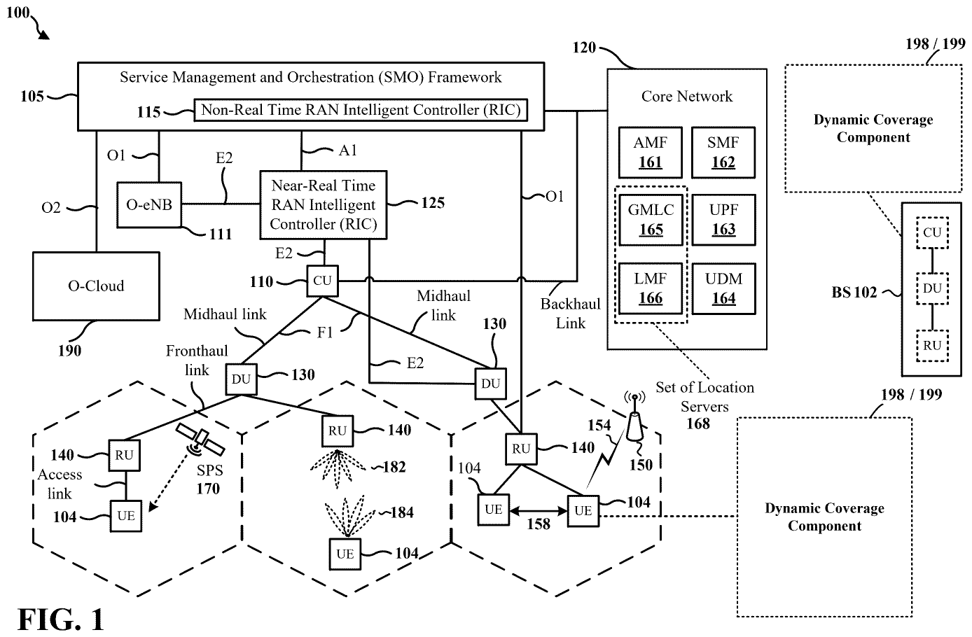

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104, the base station 102, the CU 110, the DU 130, the RU 140, the LMF 166, the AMF 161, and/or the like (e.g., the Wi-Fi AP 150, other component of the core network 120, the SPS 170, a Bluetooth device, etc.), may have a dynamic coverage component 198 (“component 198”) that may be configured to receive or retrieve first information indicative of a coverage region, where the coverage region has a common definition common for both the first network device and a set of second network devices. The component 198 may be configured to provide, to the set of second network devices, second information associated with a coverage state for the coverage region having the common definition. The component 198 may be configured to receive, from the set of second network devices, third information indicative of another coverage state of the set of second network devices. The component 198 may be configured to receive, from the set of second network devices, a second request for a second coverage state change, associated with the coverage region, for the first network device. The component 198 may be configured to receive, from the set of second network devices, a second report of a second issue, associated with the coverage region, for the first network device. The component 198 may be configured to receive, from the set of second network devices, a second set of beams, SSBs, TRPs, and cells, for the set of second network devices, associated with a second respective set of areas that comprise the coverage region. The component 198 may be configured to receive, from the set of second network devices, a second request for a second status report, associated with a second loading or a second resource availability of a second set of areas that comprise the coverage region, for the first network device. The component 198 may be configured to receive, from the set of second network devices, a second status report, associated with a second loading or a second resource availability of a second set of areas that comprise the coverage region, for the first network device. The component 198 may be configured to receive, from the set of second network devices, a second set of areas, that comprise the coverage region, for second paging of a second UE. The component 198 may be configured to receive, from the set of second network devices, a second location or a second most-recent location in the coverage region of a second UE. The component 198 may be configured to receive, from the set of second network devices, a second set of parameters associated with a second set of areas that comprise the coverage region, where the second set of parameters include at least one of a second mobility threshold or a second priority. The component 198 may be configured to receive, from the set of second network devices, a second set of energy costs for the set of second network devices. The component 198 may be configured to receive, from the set of second network devices, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. The component 198 may be configured to receive, from the set of second network devices: a second expected density, a second average density, a second number, a second expected distribution, or a second expected percentage of second idle or inactive UEs for a second set of areas that comprise the coverage region, for a second set of cells, or for a second set of beams. The component 198 may be configured to receive, from the set of second network devices: a second average, a second minimum, or a second maximum of a second signal strength or a second signal quality, in second uplink or downlink signaling, for the second set of areas, for the second set of cells, or for the second set of beams.

In certain aspects, the UE 104, the base station 102, the CU 110, the DU 130, the RU 140, the LMF 166, the AMF 161, and/or the like (e.g., the Wi-Fi AP 150, other component of the core network 120, the SPS 170, a Bluetooth device, etc.), may have a dynamic coverage component 199 (“component 199”) that may be configured to provide first information indicative of a coverage region, where the coverage region has a common definition common for both the first network device and a set of second network devices. The component 199 may be configured to receive, from the first network device, second information associated with a coverage state for the coverage region having the common definition. The component 199 may be configured to provide, for the first network device, third information indicative of another coverage state of the set of second network devices. The component 199 may be configured to provide, for the first network device, a second request for a second coverage state change, associated with the coverage region, for the first network device. The component 199 may be configured to provide, for the first network device, a second report of a second issue, associated with the coverage region, for the first network device. The component 199 may be configured to provide, for the first network device, a second set of beams, SSBs, TRPs, and cells, for the set of second network devices, associated with a second respective set of areas that comprise the coverage region. The component 199 may be configured to provide, for the first network device, a second request for a second status report, associated with a second loading or a second resource availability of a second set of areas that comprise the coverage region, for the first network device. The component 199 may be configured to provide, for the first network device, a second status report, associated with a second loading or a second resource availability of a second set of areas that comprise the coverage region, for the first network device. The component 199 may be configured to provide, for the first network device, a second set of areas, that comprise the coverage region, for second paging of a second UE. The component 199 may be configured to provide, for the first network device, a second location or a second most-recent location in the coverage region of a second UE. The component 199 may be configured to provide, for the first network device, a second set of parameters associated with a second set of areas that comprise the coverage region, where the second set of parameters include at least one of a second mobility threshold or a second priority. The component 199 may be configured to provide, for the first network device, a second set of energy costs for the set of second network devices. The component 199 may be configured to provide, for the first network device, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. The component 199 may be configured to provide, for the first network device: a second expected density, a second average density, a second number, a second expected distribution, or a second expected percentage of second idle or inactive UEs for a second set of areas that comprise the coverage region, for a second set of cells, or for a second set of beams. The component 199 may be configured to provide, for the first network device: a second average, a second minimum, or a second maximum of a second signal strength or a second signal quality, in second uplink or downlink signaling, for the second set of areas, for the second set of cells, or for the second set of beams.

Accordingly, aspects herein increase coverage efficiency with the coverage regions by utilizing commonly-/globally-defined coverage regions or zones for network devices, rather than device-specific references (e.g., such as beams/SSBs, cells, and/or the like) to define coverage, and aspects herein also improve communications associated with the configurations/reconfigurations for the coverage regions by utilizing a coverage indication framework based on the commonly-defined coverage regions.

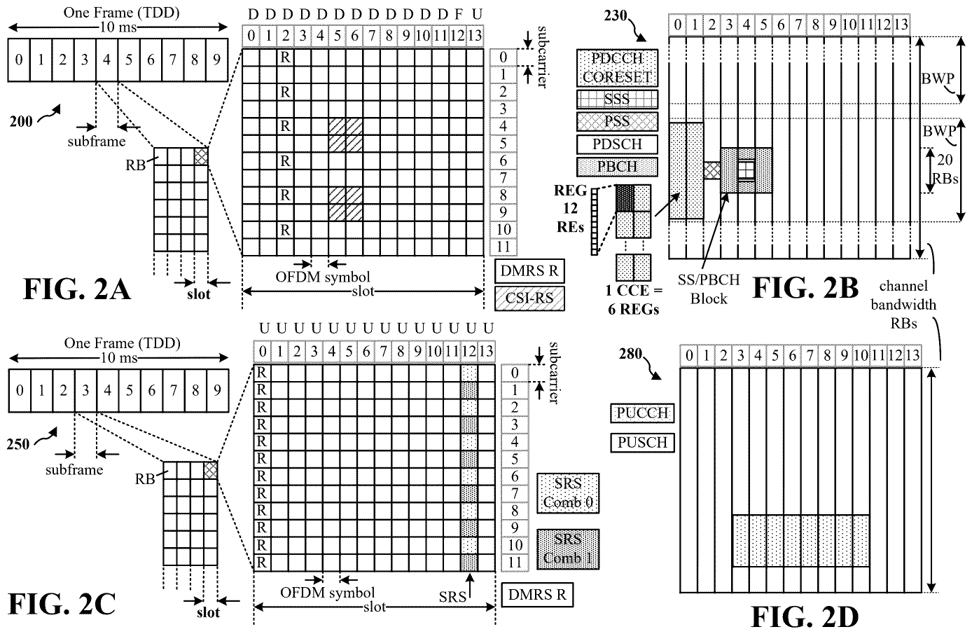

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

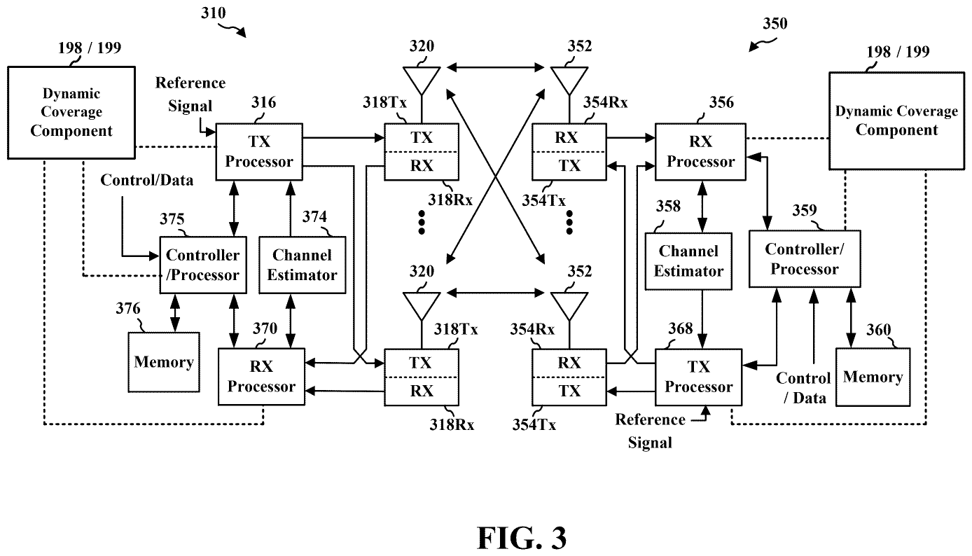

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198/component 199 of FIG. 1.

At least one of the TX processor 316, the RX processor 370, and the controller/processor 375 may be configured to perform aspects in connection with the component 198/component 199 of FIG. 1.

Wireless communication networks may support communications between network nodes (e.g., base stations, gNBs, etc.), network entities/functions (e.g., in a core network), and UEs. For instance, network nodes may communicate information between with each other for coverage configurations/reconfigurations, such as information associated with cells and/or beams of such cells, abstract coverage state values, etc. Such communication enables the network nodes to change their coverage states in an informed manner. In such scenarios, a network node may be assumed to keep a history of measurements and/or configuration settings for coverage of another network node and to utilize such information for future operations, such as requesting cell/beam activations from the other network node. In some scenarios, a network node may adopt within or change into different coverage configuration based on different requirements, such as current load, capacity etc. Such configurations may include inactive or different active states based on demand, and may attempt to utilize the configuration changes for improved energy efficiency, network energy savings, improved coverage (e.g., QoS), mobility robustness management, etc. For example, a network node that has changed its configuration may share a node configuration update message that includes impacted cell identifiers, their coverage state indicators, impacted SSB indices, and/or corresponding coverage state indicators (e.g., as mapped into integers defining inactive and different active states). In a related context, there are also procedures for exchanging cell and beam activation requests across network nodes.

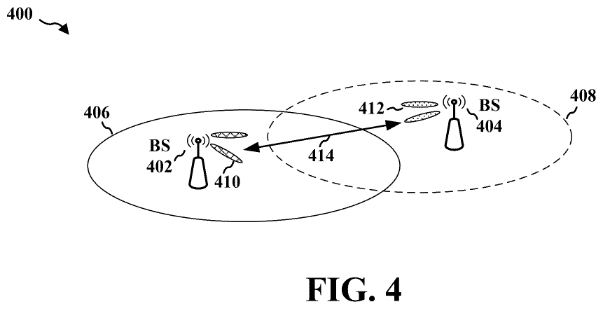

FIG. 4 is a diagram 400 illustrating an example of coverage regions, for network nodes, defined by cells, beams, or SSBs of the network nodes. Diagram 400 is shown in the context of a base station 402 and a base station 404 (e.g., network nodes, gNBs, etc.). The base station 402 may be configured to communicate/provide coverage via beams 410 (and/or SSBs associated therewith) or based on a serving cell 406. Likewise, the base station 404 may be configured to communicate/provide coverage via beams 412 (and/or SSBs associated therewith) or based on a serving cell 408. That is, the coverage regions of the base station 402 and the base station 404 are defined in accordance with respective beams, SSBs, cells, and/or the like, associated therewith. The base station 402 and the base station 404 may exchange communications 414 regarding their coverage.

Aspects presented herein provide for more efficient coverage determinations and indications of coverage. As an example, without the coordination presented herein, a first network node at time T1 may have had a first coverage configuration and may have notified a second network node about its set of active cells and beams, as well as associated coverage states (e.g., where the coverage state is a 4-bit or 6-bit logical index). The first network node, at time T2, may have changed to a second coverage state configuration (e.g., and again notified the second network node about its updated set of active cells and beams, and associated coverage states). In some cases, for energy savings, the second network node may have deactivated some of its cells and/or beams. At time T3, the second network node may determine it has load issue in a part of its coverage region (e.g., due to the adopted second coverage configuration of the first network node), and may request the first network node to activate some of its cells and beams (e.g., SSBs). Yet, for this to interaction to be utilized, the second network node should have stored/remembered which cells and SSBs of the first network node, at an earlier time (e.g., at T1), were helping with load balancing for that part of its coverage region, and use those cells and beams of the first network node as a reference for making its requests. Such operations are complicated for network nodes to keep such a memory and analysis of mapping between configuration (e.g., cells/beams) of other network nodes and a network node's own coverage regions. Moreover, the first network node may change its beamforming codebook used for its SSBs, but using an SSB index (such as when it is deactivated and no longer available) to refer to a coverage region generally does not properly work.

Multiple aspects provided herein are relevant for network side optimization via various signaling exchange(s). Aspects reference coverage areas based on regions/geographical entities rather than via cells/beams to help with NES and load balancing. Aspects also cover different signaling exchanges between network devices (such as but not limited to gNBs) to convey/request/recommend coverage states relative to the coverage regions/areas. Aspects further cover further detailed considerations for various sub-scenarios. As examples, aspects herein for dynamic coverage optimization for NES provide improvements that address the issues noted above. For example, network devices may be configured with a coverage region(s) having a common definition that is common therebetween and defined independently of beams, SSBs, TRPs, and cells of network devices, a given coverage region may be made up of a number of areas, associated with unique area identifiers, configured as a set of physical areas, a set of geographic areas, and/or a set of digital area representations, coverage states may be provided for a coverage region and/or for one or more coverage areas and may be indicated based on coverage state indices (e.g., a set of common logical indices), and a coverage indication framework may be utilized between network devices to facilitate communication of coverage state information based on the common coverage region/areas. Accordingly, aspects herein increase coverage efficiency with the coverage regions by utilizing commonly-/globally-defined coverage regions or zones for network devices, rather than device-specific references (e.g., such as beams/SSBs, cells, and/or other gNB-/bases station-specific coverage definitions) to define coverage, and aspects herein also improve communications associated with the configurations/reconfigurations for the coverage regions by utilizing a coverage indication framework based on the commonly-defined coverage regions.

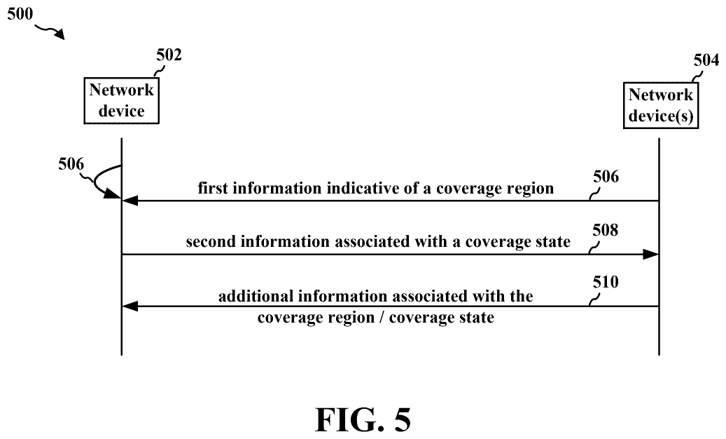

FIG. 5 is a call flow diagram 500 for wireless communications, in various aspects. Call flow diagram 500 illustrates dynamic coverage optimization for NES for a first network device 502 (e.g., a UE, a network node (such as a base station, a gNB, etc.), a network entity, a core network function (an LMF, an AMF, etc.)) by way of example, that communicates with a set of second network devices 504 (e.g., one or more of a UE(s), a network node(s) (such as a base station, a gNB, a CU, a DU, an RU, etc.), a network entity(ies), a core network function(s) (an LMF, an AMF, etc.), as shown and described herein), by way of example. Aspects described for network nodes/entities herein, generally, may be performed in aggregated form and/or by one or more components in disaggregated form. Additionally, or alternatively, the aspects may be performed by the first network device 502 autonomously, in addition to, and/or in lieu of, operations of the set of second network devices 504.

The first network device 502 may be configured to receive or retrieve first information 506 indicative of a coverage region. In aspects, the coverage region may have a common definition common for both the first network device 502 and the set of second network devices 504. In aspects, to receive the first information 506, the first network device 502 may be configured receive, and the set of second network devices 504 may be configured to transmit/provide, a configuration or an update associated with at least one of the coverage region or second information 508 associated with the coverage state for the coverage region. In some aspects, to retrieve the first information 506, the first network device 502 may be configured to retrieve, based on a prior configuration of the first network device 502 (e.g., stored in a memory of the first network device 502), a configuration or an update associated with at least one of the coverage region or the second information 508 associated with the coverage state for the coverage region. In aspects, the common definition may be defined independently of beams, SSBs, TRPs, cells, and/or the like, of the set of second network devices 504 and/or of the first network device 502. As used herein, the term “provide” and the term “transmit” may be used interchangeably in some aspects in the context of wireless communications and/or in the context of wire-based communications.

In aspects, the coverage region may be based on a set of areas comprising at least one of a set of physical areas, a set of geographic areas, or a set of digital area representations. In such aspects, each area of the set of areas may be associated with a unique area identifier (ID). The set of areas may be based on at least one of geographic coordinates, a set of references to wireless device identifiers (IDs), regular geometries, irregular geometries, and/or the like. In some aspects, the coverage state for the coverage region may comprise a set of coverage states for each area of the set of areas. Additionally, a respective common logical index of a set of common logical indices may be comprised in the second information and may be indicative of each coverage state of the set of coverage states.

The first network device 502 may be configured to transmit/provide, and the set of second network devices 504 may be configured to receive, second information 508 associated with a coverage state for the coverage region having the common definition. The second information 508 may include an indication of the coverage state as a set of coverage states for the first network device over a set of areas that comprise the coverage region. In such aspects, each coverage state of the set of coverage states may be (i) associated with a configured quality of service (QoS) for areas of the set of areas and is (ii) indicative of an activated state, a deactivated state, a partially activated state, or a partially deactivated state. In aspects, a request for a coverage state change may be indicative of an activation, a deactivation, or another configuration alteration of the coverage state. The second information 508 may comprise a first request for a first coverage state change, associated with the coverage region, for the set of second network devices. The second information 508 may be indicative of a first report of a first issue, associated with the coverage region, for the set of second network devices. In such aspects, the first issue may be associated with a coverage, a load, or an interference for a set of areas that comprise the coverage region. The second information 508 may be indicative of a first set of beams, SSBs, TRPs, and cells, for the first network device, associated with a first respective set of areas that comprise the coverage region. The second information 508 may be indicative of a first request for a first status report, associated with a first loading or a first resource availability of a first set of areas that comprise the coverage region, for the set of second network devices. The second information 508 may be indicative of a first status report, associated with a first loading or a first resource availability of a first set of areas that comprise the coverage region, for the set of second network devices. The second information 508 may be indicative of a first set of areas, that comprise the coverage region, for first paging of a first UE. The second information 508 may be indicative of a first location or a first most-recent location in the coverage region of a first UE. The second information 508 may be indicative of a first set of parameters associated with a first set of areas that comprise the coverage region. In such aspects, the first set of parameters may include at least one of a first mobility threshold or a first priority. In aspects, a set of energy costs may be associated with a set of areas that comprise the coverage region. The second information 508 may be indicative of a first set of energy costs for the first network device. The second information 508 may be indicative of a first set of replacement beam identifiers associated with a first set of areas that comprise the coverage region. In such aspects, the first set of replacement beam identifiers may be indicative of a first set of replacement beams as a first replacement for at least a first portion of a first set of active beams associated with the first set of areas. The second information 508 may be indicative of a first expected density, a first average density, a first number, a first expected distribution, or a first expected percentage of first idle or inactive UEs for a first set of areas that comprise the coverage region, for a first set of cells, or for a first set of beams. The second information 508 may be indicative of a first average, a first minimum, or a first maximum of a first signal strength or a first signal quality, in first uplink or downlink signaling, for the first set of areas, for the first set of cells, or for the first set of beams.

Various aspects herein provide for any combination of the second information 508 described herein, and the described aspects for the second information 508 are not to be construed as mutually exclusive of each other.

The first network device 502 may be configured to receive, and the set of second network devices 504 may be configured to transmit/provide, additional information 510 associated with the coverage state or the coverage region having the common definition. In aspects, the additional information 510 may comprise third information, and in some aspects, the additional information 510/the third information may be received in association with provision of the second information 508 by the first network device 502. In some aspects, such as for prior configurations of the first network device 502, the first information 506 may comprise one or more aspects described herein for the additional information 510.

In one example, the additional information 510 may be third information indicative of another coverage state of the set of second network devices. In one example, the additional information 510 may be third information including a second request for a second coverage state change, associated with the coverage region, for the first network device. In one example, the additional information 510 may be third information including a second report of a second issue, associated with the coverage region, for the first network device. In one example, the additional information 510 may be third information including a second set of beams, SSBs, TRPs, and cells, for the set of second network devices, associated with a second respective set of areas that comprise the coverage region. In one example, the additional information 510 may be third information including a second request for a second status report, associated with a second loading or a second resource availability of a second set of areas that comprise the coverage region, for the first network device. In one example, the additional information 510 may be third information including a second status report, associated with a second loading or a second resource availability of a second set of areas that comprise the coverage region, for the first network device. In one example, the additional information 510 may be third information including a second set of areas, that comprise the coverage region, for second paging of a second UE. In one example, the additional information 510 may be third information including a second location or a second most-recent location in the coverage region of a second UE. In one example, the additional information 510 may be third information including a second set of parameters associated with a second set of areas that comprise the coverage region, where the second set of parameters include at least one of a second mobility threshold or a second priority. In one example, the additional information 510 may be third information including a second set of energy costs for the set of second network devices. In one example, the additional information 510 may be third information including a second set of replacement beam identifiers associated with a second set of areas that comprise the coverage region. In such aspects, the second set of replacement beam identifiers may be indicative of a second set of replacement beams as a second replacement for at least a second portion of a second set of active beams associated with the second set of areas. In one example, the additional information 510 may be third information including one or more of a second expected density, a second average density, a second number, a second expected distribution, or a second expected percentage of second idle or inactive UEs for a second set of areas that comprise the coverage region, for a second set of cells, or for a second set of beams. In one example, the additional information 510 may be third information including one or more of a second average, a second minimum, or a second maximum of a second signal strength or a second signal quality, in second uplink or downlink signaling, for the second set of areas, for the second set of cells, or for the second set of beams.

Aspects herein provide for different combinations of entities associated with a wireless network to utilize the techniques herein for dynamic coverage optimization for NES. In one example, the first network device 502 may be a first network node and the set of second network devices 504 may comprise a second network node. In one example, the first network device 502 may be the first network node and the set of second network devices 504 may comprise a UE (e.g., the UE 104 in FIG. 1). In one example, the first network device 502 may be the first network node and the set of second network devices 504 may comprise a first core network function. In one example, the first network device 502 may be a second core network function and the set of second network devices 504 may comprise the first core network function. Aspects also include other options/combinations, as described herein, for the first network device 502 and the set of second network devices 504. By way of example and not limitation, the first network node and the second network node may be at least one of a base station/a gNB (e.g., the BS 102 in FIG. 1), a central unit (e.g., the CU 110 in FIG. 1), a distributed unit (e.g., the DU 130 in FIG. 1), or a radio unit (e.g., the RU 140 in FIG. 1), the first core network function and the second core network function may be at least one of a location management function (e.g., the LMF 166 in FIG. 1) or an access and mobility management function (e.g., the AMF 161 in FIG. 1), and/or the like, as described herein.

In some aspects, location report procedures may utilize dynamic coverage optimization for NES, as described herein. For example, a base station/gNB (or a network node, generally) may be configured to report to the core network that a UE has entered/exited the coverage region with the common definition. In such aspects, a configuration from the core network may be provided to network nodes for the reporting. In some aspects, positioning procedures may utilize dynamic coverage optimization for NES, as described herein. For example, a base station/gNB (or a network node, generally) may be configured to report to an LMF regarding its TRP, including without limitation, information associated with the coverage region with the common definition. Likewise, the LMF may be configured to request a base station/gNB to activate transmission or measurements on TRPs within associated coverage regions having common definitions.

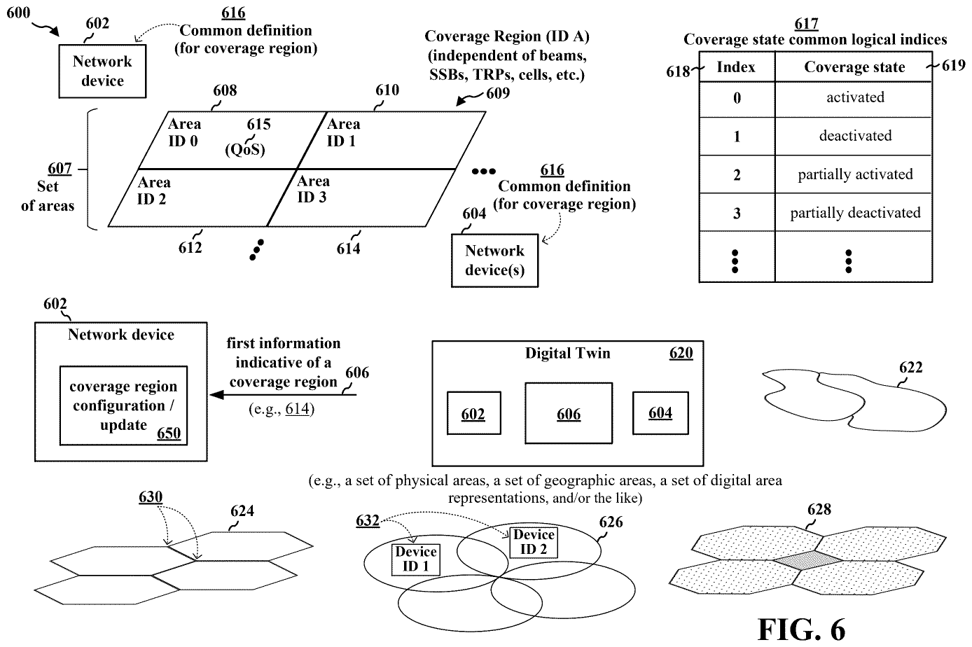

FIG. 6 is a diagram 600 illustrating coverage regions with common definitions, in various aspects. Diagram 600 illustrates dynamic coverage optimization for NES for a first network device 602 (e.g., a UE, a network node (such as a base station, a gNB, etc.), a network entity, a core network function (an LMF, an AMF, etc.)) by way of example, that communicates with a set of second network devices 604 (e.g., one or more of a UE(s), a network node(s) (such as a base station, a gNB, a CU, a DU, an RU, etc.), a network entity(ies), a core network function(s) (an LMF, an AMF, etc.), as shown and described herein), by way of example. A coverage region 609 may have a common definition 616 between the first network device 602 and the set of second network devices 604, in accordance with aspects herein. Diagram 600 may be an aspect of call flow diagram 500 in FIG. 5.

As described, aspects herein include a configuration/an update 650 to be provided via first information 606 or a pre-/prior-configuration that is stored for the first network device 602. The configuration/the update 650 may be associated with at least one of the coverage region 609 or second information (e.g., the second information 508 in FIG. 5) associated with a coverage state 619 for the coverage region 609. The configuration/the update 650 may be indicative of with a unique index or region ID (e.g., ID A) for the coverage region 609 and/or of a set of areas 607 that comprise the coverage region 609, e.g., in the vicinity of the first network device 602 and the set of second network devices 604. As shown, by way of example for illustrative clarity and descriptive brevity, four areas of the set of areas 607 may comprise the coverage region 609: an area 608 having a unique identifier ID 0, an area 610 having a unique identifier ID 1, an area 612 having a unique identifier ID 2, and an area 614 having a unique identifier ID 3.

The coverage region 609 and/or the areas of the set of areas 607 may be based on/defined with respect to at least one of a set of physical areas, a set of geographic areas, or a set of digital area representations, where each area of the set of areas 607 may be associated with a unique area identifier (e.g., ID 0, ID 1, ID 2, ID 3, etc.). As one example, the coverage region 609 and/or the areas of the set of areas 607 may be based on/defined with respect to a digital twin 620 comprising the set of digital area representations. The digital twin 620 may be a virtual model of the coverage region 609 and/or the areas of the set of areas 607 in association with/accessible by the first network device 602 and the set of second network devices 604. The digital twin 620 may be based on historical and/or real time/near real time information (e.g., based on sensors, maps, signaling, device movement/activation/deactivation/state, and/or the like) by which the coverage region 609 and/or the areas of the set of areas 607 may be commonly defined for the first network device 602 and the set of second network devices 604. Accordingly, the coverage region 609 may be associated with an index to a region/set of areas and/or a configuration of a set of configurations comprised in the digital twin 620.

In aspects, a set of physical areas, a set of geographic areas, and/or the digital twin 620 may be based on at least one of geographic coordinates 630 such as geo-location coordinates, a set of references to wireless device identifiers 632 (e.g., for WLAN/Wi-Fi devices, Bluetooth devices, etc.), regular geometries (e.g., a regular geometry 624, a regular geometry 626, a regular geometry 628, and/or the like), irregular geometries (e.g., an irregular geometry 622), etc. In various aspects, such areas (e.g., of the set of areas 607) may be overlapping or non-overlapping, may tesselate, may be contiguous or non-contiguous, and/or the like. Aspects also provide for the coverage region 609 and/or the areas of the set of areas 607 to be commonly defined based on geo-political boundaries, urban demarcations (e.g., streets, city blocks, structures, etc.), rural demarcations (e.g., rivers, regions of diverse elevation, roads, etc.), and/or the like. The coverage region 609 and/or the areas of the set of areas 607 may be determined/configured/updated “over-the-top,” e.g., by OAM and outside the scope of standardization, or may be determined/configured/updated via signaling between the first network device 602 and the set of second network devices 604 (e.g., as first information described herein) via an F1 interface, an Xn interface, and/or the like. Accordingly, procedures and signaling for configuring/updating coverage regions/areas (e.g., by providing a range of locations/representations/delimiters associated with a coverage region along with a unique index or region ID (e.g., ID A)) are provided for the aspects described herein. In either case above, standardized interfaces (e.g., Uu, F1, Xn, etc.) between different network devices may support the signaling and procedure with a reference to the defined coverage regions (e.g., via a list of one or multiple coverage region IDs or indices), as described in further detail below.

In aspects, the coverage region 609 and/or an area(s) of the set of areas 607 may have respective states for the coverage state 619, which may be associated with a configured quality of service (QoS) 615 for the areas of the set of areas 607, and which may be (ii) indicative of an activated state, a deactivated state, a partially activated state, a partially deactivated state, and/or the like. Coverage state common logical indices 617 may associate an index 618 value with the coverage state 619 for the coverage states. In aspects, the coverage state 619 may correspond to a specific targeted area, a load, an interference threshold, etc. As one example, the target of the coverage state 619 may be associated with provision of a target coverage in a given region/area for a given traffic load.

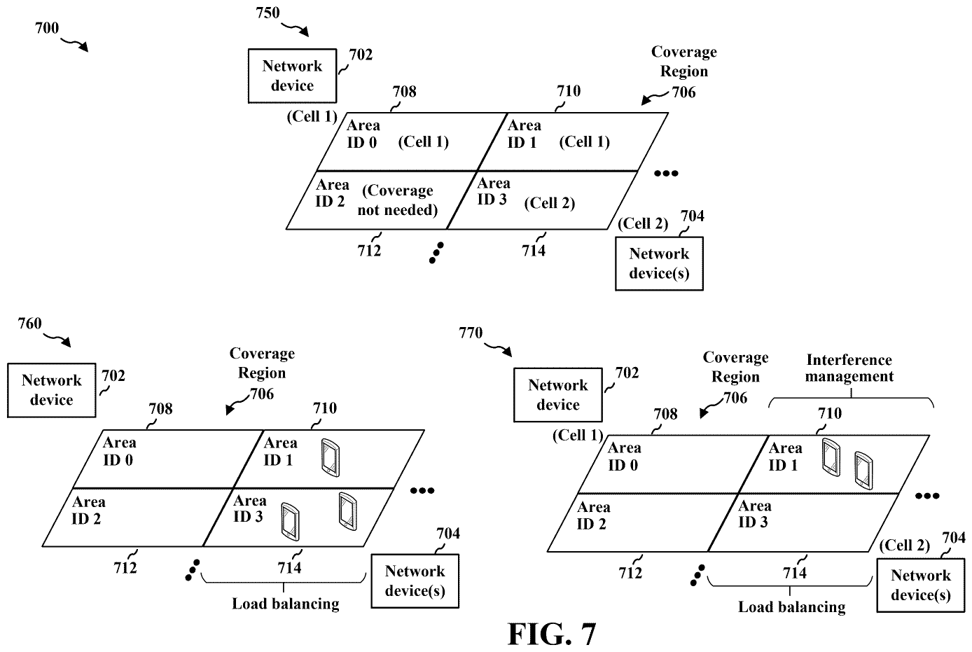

FIG. 7 is a diagram 700 illustrating dynamic optimizations for coverage regions with common definitions, in various aspects. Diagram 700 illustrates dynamic coverage optimization for NES for a first network device 702 (e.g., a UE, a network node (such as a base station, a gNB, etc.), a network entity, a core network function (an LMF, an AMF, etc.)) by way of example, that communicates with a set of second network devices 704 (e.g., one or more of a UE(s), a network node(s) (such as a base station, a gNB, a CU, a DU, an RU, etc.), a network entity(ies), a core network function(s) (an LMF, an AMF, etc.), as shown and described herein), by way of example. Diagram 700 may be an aspect of diagram 600 in FIG. 6.

A coverage region 706 may have a common definition between the first network device 702 and the set of second network devices 704, in accordance with aspects herein. As shown, by way of example for illustrative clarity and descriptive brevity, four areas of a set of areas may comprise the coverage region 706: an area 708 having a unique identifier ID 0, an area 710 having a unique identifier ID 1, an area 712 having a unique identifier ID 2, and an area 714 having a unique identifier ID 3. Diagram 700 illustrates example scenarios for dynamic coverage optimization for NES: a scenario 750, a scenario 760, and a scenario 770.

In scenario 750, the first network device 702 may be configured to indicate its intended coverage state(s) in a list of areas for the coverage region 706 (e.g., the area 712 with unique ID 2 and the area 714 with unique ID 3) for energy savings. The first network device 702 may be configured to request the set of second network devices 704 to activate coverage in a list of areas for the coverage region 706.

For a connected mode, this decision may be made as requesting an available resource report for the coverage region 706 from the set of second network devices 704, and/or additionally requesting an associated energy cost(s) to those areas. If the resource(s) is (are) sufficient, and the energy cost(s) is (are) less that the gain that can be achieved from changing the coverage state, the first network device 702 may be configured to request an activation of coverage for those areas of the coverage region 706 from the set of second network devices 704.

For an idle mode, this decision may be made based on historical data of a UE(s) presence in those areas of the coverage region 706. Accordingly, aspects provide a benefit for a given network deployment as resource management for energy savings is simpler at the level of the coverage region 706/the areas, and in idle mode coverage, historical UE(s) information may enable decision making to update coverage states (e.g., active to inactive cells).

In scenario 760, with reference to load balancing, the first network device 702 may be serving a certain area(s) of the coverage region 706, and may wish to hand that region over to a network device of the set of second network devices 704, e.g., due to capacity limitations and/or overload. The first network device 702 may be configured to activate coverage in a list of areas for the coverage region 706 (e.g., the area 710 with unique ID 1 and the area 714 with unique ID 3). The first network device 702 may be configured to indicate its current coverage state for these unique area IDs, along with the capacity requirement. The first network device 702 may be configured to additionally request its intended coverage state for such areas/unique area IDs. The first network device 702 may be configured to request a resource status report of one or more network devices of the set of second network devices 704 associated with specific areas of the coverage region 706 (e.g., the area 710 with unique ID 1 and the area 714 with unique ID 3).

The receiving device(s) of the set of second network devices 704 may be configured to share its available resource for the indicated areas of the coverage region 706 and/or any additional resources it can allocate. Such an indication may be based on prior information about serving the specific areas of the coverage region 706. If the available resource is sufficient, the coverage area(s) may be handed over to the receiving device(s) of the set of second network devices 704. Accordingly, aspects provide a benefit here as the areas/coverage region 706 may be pre-defined and at a more granular level that other solutions, and thus, it is easier for network devices to manage resources at a per-area/per-coverage region level and does not change significantly due to the coverage definition being aligned with the areas/coverage region 706 rather than with cells/beams SSBs.

In scenario 770, with reference to interference management, aspects also provide benefits as currently there are no related solutions for 5G NR except for cross cell interference. For instance, the commonly-defined nature of the coverage region 706 provides aspects for interference management. The first network device 702 may be serving a certain area(s) of the coverage region 706 (e.g., the area 710 with unique ID 1), and may experience interference from a network device(s) of the set of second network devices 704. The first network device 702 may be configured to request, from the set of second network devices 704 an indication of which cells/beams/SSBs are associated with a list of areas for the coverage region 706 in proximity. The first network device 702 may be configured to indicate, e.g., in the request, its current coverage state for an area(s) of the coverage region 706 along with any of its associated cells/beams (e.g., beam IDs)/SSBs. The first network device 702 may also be configured to request the set of second network devices 704 to deactivate coverage in a list of areas of the coverage region 706 (e.g., the area 710 with unique ID 1) with specific interfering cell IDs (e.g., when such cell IDs are global IDs).

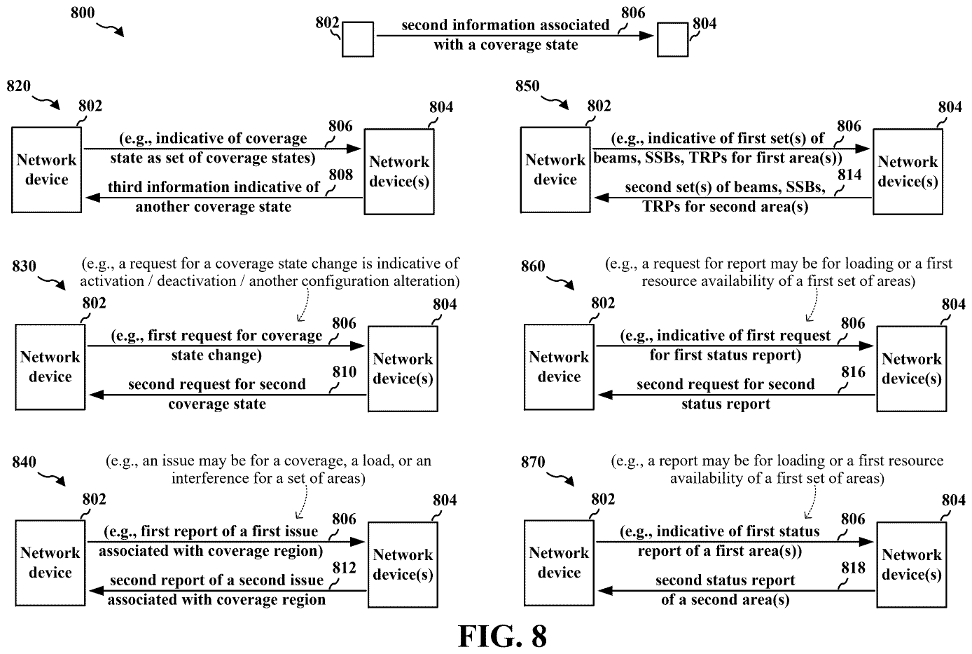

FIG. 8 is a diagram 800 illustrating information exchange for dynamic optimizations of coverage states and coverage regions with common definitions, in various aspects. Diagram 800 illustrates dynamic coverage optimization for NES for a first network device 802 (e.g., a UE, a network node (such as a base station, a gNB, etc.), a network entity, a core network function (an LMF, an AMF, etc.)) by way of example, that communicates with a set of second network devices 804 (e.g., one or more of a UE(s), a network node(s) (such as a base station, a gNB, a CU, a DU, an RU, etc.), a network entity (ies), a core network function(s) (an LMF, an AMF, etc.), as shown and described herein), by way of example. Diagram 800 may be an aspect of call flow diagram 500 in FIG. 5, diagram 600 in FIG. 6, and/or diagram 700 in FIG. 7. Diagram 800 is illustrated with reference to second information 806, which may be an aspect of the second information 508 in FIG. 5. The first network device 802 may be configured to transmit/provide, and the set of second network devices 804 may be configured to receive, the second information 806 that is associated with a coverage state, e.g., for a coverage indication framework.

In a scenario 820, the second information 806, associated with a coverage state, may be an indication/indicative of the coverage state as a set of coverage states for the first network device 802 over a set of areas that comprise the coverage region. In aspects, each coverage state of the set of coverage states may be (i) associated with a configured QoS for areas of the set of areas and may be (ii) indicative of an activated state, a deactivated state, a partially activated state, or a partially deactivated state. For instance, the first network device 802 may be configured to indicate its coverage state for a list of one or multiple areas of a coverage region. The coverage state may be deactivated and activated, and may be multiple states in between, representing the adopted configuration or target/guaranteed QoS associated with a coverage region/area.

In addition and/or in response, or alternatively, the first network device 802 may be configured to receive, and the set of second network devices 804 may be configured to transmit/provide, third information 808 indicative of another coverage state of the set of second network devices 804, which may be analogous for the perspective of the set of second network devices 804, to the second information 806 for the first network device 802.

In a scenario 830, the second information 806, associated with a coverage state, may comprise a first request for a first coverage state change, associated with the coverage region, for the set of second network devices 804. In aspects, a request for a coverage state change may be indicative of an activation, a deactivation, or another configuration alteration of the coverage state. For instance, the first network device 802 may be configured to request the set of second network devices 804 to change a coverage state(s) for a list of one or multiple areas of a coverage region. The request may be to deactivate (e.g., for interference purposes), to activate (e.g., for load balancing purposes), or to adopt a different configuration (e.g., by referring to a previously indicated coverage state and/or referring to a target QoS).

In addition and/or in response, or alternatively, the first network device 802 may be configured to receive, and the set of second network devices 804 may be configured to transmit/provide, third information 810 indicative of a second request for a second coverage state change, associated with the coverage region, for the first network device 802, which may be analogous for the perspective of the set of second network devices 804, to the first request from the first network device 802. In some aspects, the third information 810 may be a request response to the first request comprised in the second information 806 by which the set of second network devices 804 may inform the first network device 802 whether the first request will be accommodated or not (including partial accommodation).

In a scenario 840, the second information 806, associated with a coverage state, may be indicative of a first report of a first issue, associated with the coverage region, for the set of second network devices 804. In such aspects, the first issue may be associated with a coverage, a load, or an interference for a set of areas that comprise the coverage region. For instance, the first network device 802 may be configured to report to the set of second network devices 804 an issue (e.g., for coverage, capacity/load, interference, etc.), along with a list of areas of a coverage region.

In addition and/or in response, or alternatively, the first network device 802 may be configured to receive, and the set of second network devices 804 may be configured to transmit/provide, third information 812 indicative of a second report of a second issue, associated with the coverage region, for the first network device 802, which may be analogous for the perspective of the set of second network devices 804, to the first report from the first network device 802.

In a scenario 850, the second information 806, associated with a coverage state, may be indicative of a first set of beams, SSBs, TRPs, and/or cells, for the first network device 802, associated with a first respective set of areas that comprise the coverage region. For instance, the first network device 802 may be configured to indicate which of its cells/beams (SSBs)/TRPs are associated with a list of areas for a coverage region.

In addition and/or in response, or alternatively, the first network device 802 may be configured to receive, and the set of second network devices 804 may be configured to transmit/provide, third information 814 indicative of a second set of beams, SSBs, TRPs, and/or cells, for the set of second network devices 804, associated with a second respective set of areas that comprise the coverage region, which may be analogous for the perspective of the set of second network devices 804, to the first set of beams, SSBs, TRPs, and/or cells from the first network device 802.

In a scenario 860, the second information 806, associated with a coverage state, may be indicative of a first request for a first status report, associated with a first loading or a first resource availability of a first set of areas that comprise the coverage region, for the set of second network devices 804. For instance, the first network device 802 may be configured to request a resource/load status report of the set of second network devices 804 associated to a specific areas of a coverage region.

In addition and/or in response, or alternatively, the first network device 802 may be configured to receive, and the set of second network devices 804 may be configured to transmit/provide, third information 816 indicative of a first request for a first status report, associated with a first loading or a first resource availability of a first set of areas that comprise the coverage region, for the set of second network devices 804, which may be analogous for the perspective of the set of second network devices 804, to the first request for a first status report from the first network device 802. In some aspects, the third information 816 may be a request response to the first request comprised in the second information 806 by which the set of second network devices 804 may inform the first network device 802 whether the first request will be accommodated or not (including partial accommodation).

In a scenario 870, the second information 806, associated with a coverage state, may be of a first status report, associated with a first loading or a first resource availability of a first set of areas that comprise the coverage region, for the set of second network devices 804. For instance, the first network device 802 may be configured to provide/transmit a resource/load status report of the set of second network devices 804 associated to a specific areas of a coverage region.

In addition and/or in response, or alternatively, the first network device 802 may be configured to receive, and the set of second network devices 804 may be configured to transmit/provide, third information 818 indicative of a second status report, associated with a second loading or a second resource availability of a second set of areas that comprise the coverage region, for the first network device 802, which may be analogous for the perspective of the set of second network devices 804, to the first status report from the first network device 802.

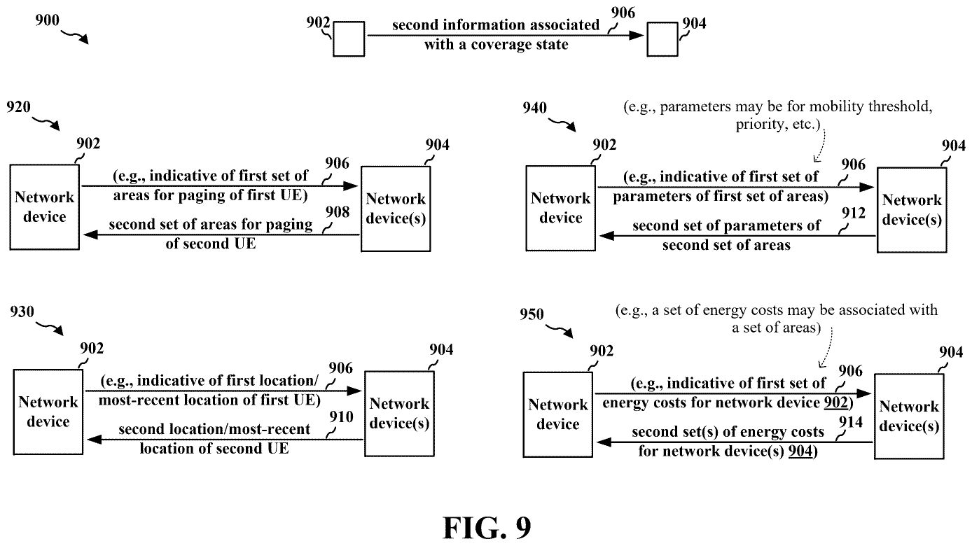

FIG. 9 is a diagram 900 illustrating information exchange for dynamic optimizations of coverage states and dynamic coverage regions with common definitions, in various aspects. Diagram 900 illustrates dynamic coverage optimization for NES for a first network device 902 (e.g., a UE, a network node (such as a base station, a gNB, etc.), a network entity, a core network function (an LMF, an AMF, etc.)) by way of example, that communicates with a set of second network devices 904 (e.g., one or more of a UE(s), a network node(s) (such as a base station, a gNB, a CU, a DU, an RU, etc.), a network entity(ies), a core network function(s) (an LMF, an AMF, etc.), as shown and described herein), by way of example. Diagram 900 may be an aspect of call flow diagram 500 in FIG. 5, diagram 600 in FIG. 6, diagram 700 in FIG. 7, and/or diagram 800 in FIG. 8. Diagram 900 is illustrated with reference to second information 906, which may be an aspect of the second information 508 in FIG. 5. The first network device 902 may be configured to transmit/provide, and the set of second network devices 904 may be configured to receive, the second information 906 that is associated with a coverage state, e.g., for a coverage indication framework.

In a scenario 920, the second information 906, associated with a coverage state, may be indicative of a first set of areas, that comprise the coverage region, for first paging of a first UE. For instance, first network device 902 may be configured to transmit/provide, and the set of second network devices may be configured to receive, information about a list of recommended areas of a coverage region for paging a UE (e.g., for an exchange of information).

In addition and/or in response, or alternatively, the first network device 902 may be configured to receive, and the set of second network devices 904 may be configured to transmit/provide, third information 908 indicative of a second set of areas, that comprise the coverage region, for second paging of a second UE, which may be analogous for the perspective of the set of second network devices 904, to the first set of areas from the first network device 902.

In a scenario 930, the second information 906, associated with a coverage state, may be indicative of a first location or a first most-recent location in the coverage region of a first UE. For instance, first network device 902 may be configured to transmit/provide, and the set of second network devices may be configured to receive, information about the current/last/most-recent location of the UE (e.g., as idle/inactive UE) based on one or multiple areas of a coverage region (e.g., for an exchange of information).

In addition and/or in response, or alternatively, the first network device 902 may be configured to receive, and the set of second network devices 904 may be configured to transmit/provide, third information 910 indicative of a second location or a second most-recent location in the coverage region of a second UE, which may be analogous for the perspective of the set of second network devices 904, to the a first location or a first most-recent location from the first network device 902.

In a scenario 940, the second information 906, associated with a coverage state, may be indicative of a first set of parameters associated with a first set of areas that comprise the coverage region, where the first set of parameters include at least one of a first mobility threshold or a first priority. For instance, one or more parameters may be defined specific to an area(s) of a coverage region (e.g., mobility related thresholds, priority, etc.).

In addition and/or in response, or alternatively, the first network device 902 may be configured to receive, and the set of second network devices 904 may be configured to transmit/provide, third information 912 indicative of a second set of parameters associated with a second set of areas that comprise the coverage region, where the second set of parameters include at least one of a second mobility threshold or a second priority, which may be analogous for the perspective of the set of second network devices 904, to the a first set of parameters from the first network device 902.

In a scenario 950, the second information 906, associated with a coverage state, may be indicative of a first set of energy costs for the first network device 902. For instance, a set of energy costs is associated with a set of areas that comprise a coverage region.

In addition and/or in response, or alternatively, the first network device 902 may be configured to receive, and the set of second network devices 904 may be configured to transmit/provide, third information 914 indicative of a second set of energy costs for the set of second network devices 904, which may be analogous for the perspective of the set of second network devices 904, to the a first set of energy costs from the first network device 902.

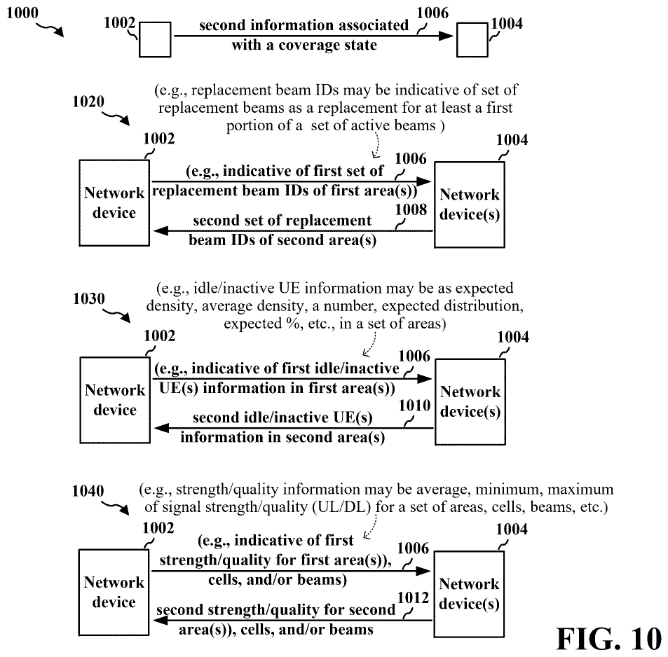

FIG. 10 is a diagram 1000 illustrating information exchange for dynamic optimizations of coverage states and dynamic coverage regions with common definitions, in various aspects. Diagram 1000 illustrates dynamic coverage optimization for NES for a first network device 1002 (e.g., a UE, a network node (such as a base station, a gNB, etc.), a network entity, a core network function (an LMF, an AMF, etc.)) by way of example, that communicates with a set of second network devices 1004 (e.g., one or more of a UE(s), a network node(s) (such as a base station, a gNB, a CU, a DU, an RU, etc.), a network entity(ies), a core network function(s) (an LMF, an AMF, etc.), as shown and described herein), by way of example. Diagram 1000 may be an aspect of call flow diagram 500 in FIG. 5 and/or diagram 600 in FIG. 6. Diagram 1000 is illustrated with reference to second information 1006, which may be an aspect of the second information 508 in FIG. 5. The first network device 1002 may be configured to transmit/provide, and the set of second network devices 1004 may be configured to receive, the second information 1006 that is associated with a coverage state, e.g., for a coverage indication framework.

In a scenario 1020, the second information 1006, associated with a coverage state, may be indicative of a first set of replacement beam identifiers associated with a first set of areas that comprise the coverage region, where the first set of replacement beam identifiers is indicative of a first set of replacement beams as a first replacement for at least a first portion of a first set of active beams associated with the first set of areas (e.g., of a coverage region). For instance, current architectures, there is a signaling support (e.g., between two gNBs) to provide a list of “Replacing Cells,” which is a set of cell IDs of the cells that may replace all or part of the coverage of the cell to be modified (e.g., deactivated). Aspects herein provide for support of information exchange about “Replacing Beams,” which may be a list of beam IDs (e.g., SSB indices) that may replace all or part of the coverage of the beam(s)/SSB(s) to be modified (e.g., deactivated).

In addition and/or in response, or alternatively, the first network device 1002 may be configured to receive, and the set of second network devices 1004 may be configured to transmit/provide, third information 1008 indicative of a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. This may be analogous for the perspective of the set of second network devices 1004, to the first set of replacement beam identifiers from the first network device 1002.

In a scenario 1030, the second information 1006, associated with a coverage state, may be indicative of (e.g., first idle/inactive UE information, such as) one or more of a first expected density, a first average density, a first number, a first expected distribution, or a first expected percentage of first idle or inactive UEs for a first set of areas that comprise the coverage region, for a first set of cells, or for a first set of beams. For instance, current architectures, there is a signaling support (e.g., between two gNBs) to report their resource/load status, e.g., in terms of number of connected UEs, RB utilization, and remaining capacity, etc., which are all associated with connected UEs, and data traffic. However, for NES and coverage optimization, information relevant to idle-mode and RF coverage is absent. Aspects herein provide for support of information exchange relevant to idle-mode and RF coverage. As an example, the first network device 1002 may be configured to provide an expected/average density (or number) of idle/inactive UEs in a given set of cell(s), beam(s) (SSB area(s)), and/or coverage regions. The first network device 1002 may also/alternatively be configured to provide an expected distribution (or a percentage) of idle/inactive UEs in a given cell/beam/coverage region.

In addition and/or in response, or alternatively, the first network device 1002 may be configured to receive, and the set of second network devices 1004 may be configured to transmit/provide, third information 1010 that includes (e.g., second idle/inactive UE information, such as) one or more of a second expected density, a second average density, a second number, a second expected distribution, or a second expected percentage of second idle or inactive UEs for a second set of areas that comprise the coverage region, for a second set of cells, or for a second set of beams. This may be analogous for the perspective of the set of second network devices 1004, to the first idle/inactive UE information from the first network device 1002.

In a scenario 1040, the second information 1006, associated with a coverage state, may be indicative of (e.g., first strength/quality information, such as) one or more of a first average, a first minimum, or a first maximum of a first signal strength or a first signal quality, in first uplink or downlink signaling, for the first set of areas, for the first set of cells, or for the first set of beams. For instance, current architectures, there is a signaling support (e.g., between two gNBs) to report their resource/load status, e.g., in terms of number of connected UEs, RB utilization, and remaining capacity, etc., which are all associated with connected UEs, and data traffic. However, for NES and coverage optimization, information relevant to idle-mode and RF coverage is absent. Aspects herein provide for support of information exchange relevant to idle-mode and RF coverage. As an example, the first network device 1002 may be configured to provide an average/minimum/maximum strength or quality (e.g., in terms of power level, reference signal received power (RSRP), reference signal received quality (RSRQ), distance, etc.) in a given cell/beam/area/coverage region (e.g., in DL and/or UL signaling scenarios).

In addition and/or in response, or alternatively, the first network device 1002 may be configured to receive, and the set of second network devices 1004 may be configured to transmit/provide, third information 1012 that includes (e.g., second strength/quality information, such as) one or more of a second average, a second minimum, or a second maximum of a second signal strength or a second signal quality, in second uplink or downlink signaling, for the second set of areas, for the second set of cells, or for the second set of beams. This may be analogous for the perspective of the set of second network devices 1004, to the first strength/quality information from the first network device 1002.

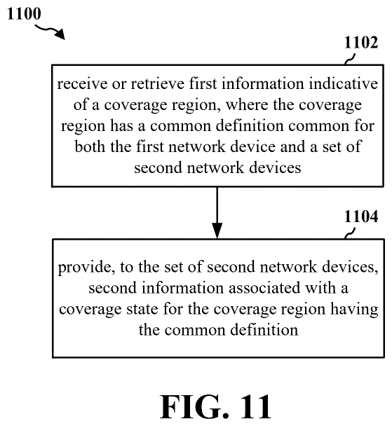

FIG. 11 is a flowchart 1100 of a method of wireless communication. The method may be performed by a first network device (e.g., the UE 104; the apparatus 1204; e.g., the base station 102, the CU 110, the DU 130, the RU 140, a gNB, etc.; a core network function/component: the LMF 166, the AMF 161, etc.; the network entity 1202, 1302, 1460). The method may be for dynamic coverage optimization for NES. The method may enable increased coverage efficiency with the coverage regions by utilizing commonly-/globally-defined coverage regions or zones for network devices, rather than device-specific references (e.g., such as beams/SSBs, cells, and/or the like) to define coverage, and may also enable improved communications associated with the configurations/reconfigurations for the coverage regions by utilizing a coverage indication framework based on the commonly-defined coverage regions.

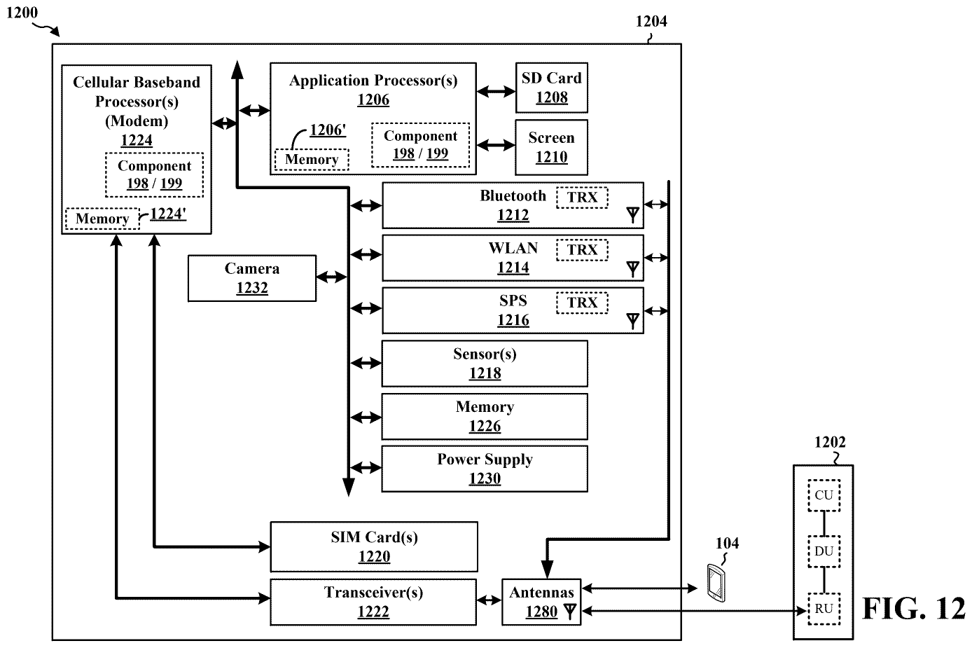

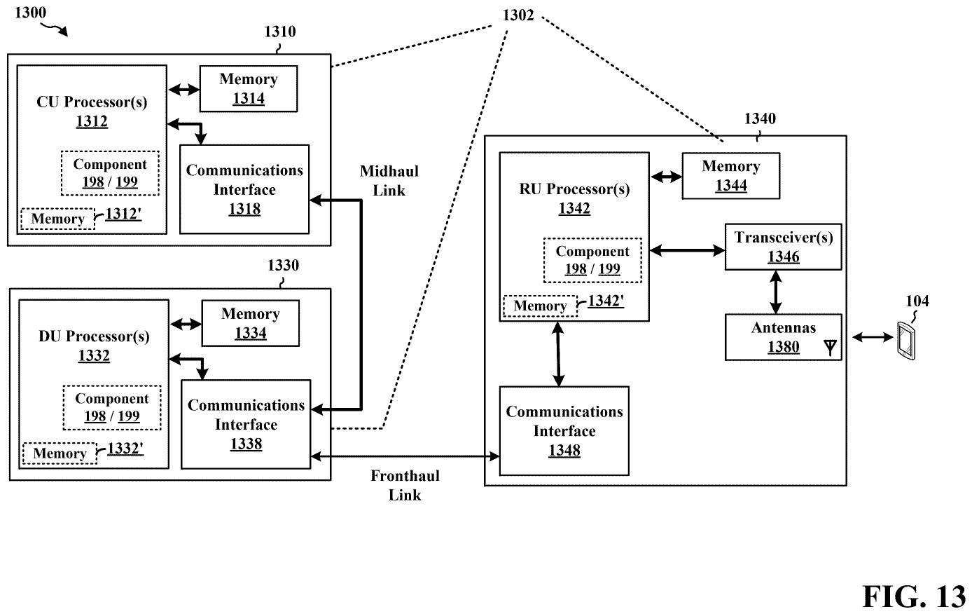

At 1102, the first network device receives or retrieves first information indicative of a coverage region, where the coverage region has a common definition common for both the first network device and a set of second network devices. As an example, the reception or retrieval may be performed by one or more of the component 198, the transceiver(s) 1222, and/or the antennas 1280 in FIG. 12 and/or by one or more of the component 199, the transceiver(s) 1346, and/or the antennas 1380 in FIG. 13. FIG. 5 illustrates, in the context of FIGS. 6, 7, 8, 9, 10, an example of a first network device (e.g., the first network device 502) receiving (e.g., from the set of second network devices 504) or retrieving such first information indicative of a coverage region.

The first network device 502 may be configured to receive or retrieve first information 506 indicative of a coverage region. In aspects, the coverage region may have a common definition common for both the first network device 502 and the set of second network devices 504. In aspects, to receive the first information 506, the first network device 502 may be configured receive, and the set of second network devices 504 may be configured to transmit/provide, a configuration or an update associated with at least one of the coverage region or second information 508 associated with the coverage state for the coverage region. In some aspects, to retrieve the first information 506, the first network device 502 may be configured to retrieve, based on a prior configuration of the first network device 502 (e.g., stored in a memory of the first network device 502), a configuration or an update associated with at least one of the coverage region or the second information 508 associated with the coverage state for the coverage region. In aspects, the common definition may be defined independently of beams, SSBs, TRPs, cells, and/or the like, of the set of second network devices 504 and/or of the first network device 502.

In aspects, the coverage region may be based on a set of areas comprising at least one of a set of physical areas, a set of geographic areas, or a set of digital area representations. In such aspects, each area of the set of areas may be associated with a unique area identifier (ID). The set of areas may be based on at least one of geographic coordinates, a set of references to wireless device identifiers (IDs), regular geometries, irregular geometries, and/or the like. In some aspects, the coverage state for the coverage region may comprise a set of coverage states for each area of the set of areas. Additionally, a respective common logical index of a set of common logical indices may be comprised in the second information and may be indicative of each coverage state of the set of coverage states.

At 1104, the first network device provides, to the set of second network devices, second information associated with a coverage state for the coverage region having the common definition. As an example, the reception or retrieval may be performed by one or more of the component 198, the transceiver(s) 1222, and/or the antennas 1280 in FIG. 12 and/or by one or more of the component 199, the transceiver(s) 1346, and/or the antennas 1380 in FIG. 13. FIG. 5 illustrates, in the context of FIGS. 6, 7, 8, 9, 10, an example of a first network device (e.g., the first network device 502) providing such second information associated with a coverage state to a set of second network devices (e.g., the set of second network devices 504).

The first network device 502 may be configured to transmit/provide, and the set of second network devices 504 may be configured to receive, second information 508 associated with a coverage state for the coverage region having the common definition. The second information 508 may include an indication of the coverage state as a set of coverage states for the first network device over a set of areas that comprise the coverage region. In such aspects, each coverage state of the set of coverage states may be (i) associated with a configured quality of service (QoS) for areas of the set of areas and is (ii) indicative of an activated state, a deactivated state, a partially activated state, or a partially deactivated state. In aspects, a request for a coverage state change may be indicative of an activation, a deactivation, or another configuration alteration of the coverage state. The second information 508 may comprise a first request for a first coverage state change, associated with the coverage region, for the set of second network devices. The second information 508 may be indicative of a first report of a first issue, associated with the coverage region, for the set of second network devices. In such aspects, the first issue may be associated with a coverage, a load, or an interference for a set of areas that comprise the coverage region. The second information 508 may be indicative of a first set of beams, SSBs, TRPs, and cells, for the first network device, associated with a first respective set of areas that comprise the coverage region. The second information 508 may be indicative of a first request for a first status report, associated with a first loading or a first resource availability of a first set of areas that comprise the coverage region, for the set of second network devices. The second information 508 may be indicative of a first status report, associated with a first loading or a first resource availability of a first set of areas that comprise the coverage region, for the set of second network devices. The second information 508 may be indicative of a first set of areas, that comprise the coverage region, for first paging of a first UE. The second information 508 may be indicative of a first location or a first most-recent location in the coverage region of a first UE. The second information 508 may be indicative of a first set of parameters associated with a first set of areas that comprise the coverage region. In such aspects, the first set of parameters may include at least one of a first mobility threshold or a first priority. In aspects, a set of energy costs may be associated with a set of areas that comprise the coverage region. The second information 508 may be indicative of a first set of energy costs for the first network device. The second information 508 may be indicative of a first set of replacement beam identifiers associated with a first set of areas that comprise the coverage region. In such aspects, the first set of replacement beam identifiers may be indicative of a first set of replacement beams as a first replacement for at least a first portion of a first set of active beams associated with the first set of areas. The second information 508 may be indicative of a first expected density, a first average density, a first number, a first expected distribution, or a first expected percentage of first idle or inactive UEs for a first set of areas that comprise the coverage region, for a first set of cells, or for a first set of beams. The second information 508 may be indicative of a first average, a first minimum, or a first maximum of a first signal strength or a first signal quality, in first uplink or downlink signaling, for the first set of areas, for the first set of cells, or for the first set of beams.

Various aspects herein provide for any combination of the second information 508 described herein, and the described aspects for the second information 508 are not to be construed as mutually exclusive of each other.

The first network device 502 may be configured to receive, and the set of second network devices 504 may be configured to transmit/provide, additional information 510 associated with the coverage state or the coverage region having the common definition. In aspects, the additional information 510 may comprise third information, and in some aspects, the additional information 510/the third information may be received in association with provision of the second information 508 by the first network device 502. In some aspects, such as for prior configurations of the first network device 502, the first information 506 may comprise one or more aspects described herein for the additional information 510.

In one example, the additional information 510 may be third information indicative of another coverage state of the set of second network devices. In one example, the additional information 510 may be third information including a second request for a second coverage state change, associated with the coverage region, for the first network device. In one example, the additional information 510 may be third information including a second report of a second issue, associated with the coverage region, for the first network device. In one example, the additional information 510 may be third information including a second set of beams, SSBs, TRPs, and cells, for the set of second network devices, associated with a second respective set of areas that comprise the coverage region. In one example, the additional information 510 may be third information including a second request for a second status report, associated with a second loading or a second resource availability of a second set of areas that comprise the coverage region, for the first network device. In one example, the additional information 510 may be third information including a second status report, associated with a second loading or a second resource availability of a second set of areas that comprise the coverage region, for the first network device. In one example, the additional information 510 may be third information including a second set of areas, that comprise the coverage region, for second paging of a second UE. In one example, the additional information 510 may be third information including a second location or a second most-recent location in the coverage region of a second UE. In one example, the additional information 510 may be third information including a second set of parameters associated with a second set of areas that comprise the coverage region, where the second set of parameters include at least one of a second mobility threshold or a second priority. In one example, the additional information 510 may be third information including a second set of energy costs for the set of second network devices. In one example, the additional information 510 may be third information including a second set of replacement beam identifiers associated with a second set of areas that comprise the coverage region. In such aspects, the second set of replacement beam identifiers may be indicative of a second set of replacement beams as a second replacement for at least a second portion of a second set of active beams associated with the second set of areas. In one example, the additional information 510 may be third information including one or more of a second expected density, a second average density, a second number, a second expected distribution, or a second expected percentage of second idle or inactive UEs for a second set of areas that comprise the coverage region, for a second set of cells, or for a second set of beams. In one example, the additional information 510 may be third information including one or more of a second average, a second minimum, or a second maximum of a second signal strength or a second signal quality, in second uplink or downlink signaling, for the second set of areas, for the second set of cells, or for the second set of beams.

Aspects herein provide for different combinations of entities associated with a wireless network to utilize the techniques herein for dynamic coverage optimization for NES. In one example, the first network device 502 may be a first network node and the set of second network devices 504 may comprise a second network node. In one example, the first network device 502 may be the first network node and the set of second network devices 504 may comprise a UE (e.g., the UE 104 in FIG. 1). In one example, the first network device 502 may be the first network node and the set of second network devices 504 may comprise a first core network function. In one example, the first network device 502 may be a second core network function and the set of second network devices 504 may comprise the first core network function. Aspects also include other options/combinations, as described herein, for the first network device 502 and the set of second network devices 504. By way of example and not limitation, the first network node and the second network node may be at least one of a base station/a gNB (e.g., the BS 102 in FIG. 1), a central unit (e.g., the CU 110 in FIG. 1), a distributed unit (e.g., the DU 130 in FIG. 1), or a radio unit (e.g., the RU 140 in FIG. 1), the first core network function and the second core network function may be at least one of a location management function (e.g., the LMF 166 in FIG. 1) or an access and mobility management function (e.g., the AMF 161 in FIG. 1), and/or the like, as described herein.

In some aspects, location report procedures may utilize dynamic coverage optimization for NES, as described herein. For example, a base station/gNB (or a network node, generally) may be configured to report to the core network that a UE has entered/exited the coverage region with the common definition. In such aspects, a configuration from the core network may be provided to network nodes for the reporting. In some aspects, positioning procedures may utilize dynamic coverage optimization for NES, as described herein. For example, a base station/gNB (or a network node, generally) may be configured to report to an LMF regarding its TRP, including without limitation, information associated with the coverage region with the common definition. Likewise, the LMF may be configured to request a base station/gNB to activate transmission or measurements on TRPs within associated coverage regions having common definitions.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to receive or retrieve first information indicative of a coverage region, where the coverage region has a common definition common for both the first network device and a set of second network devices. The component 198 may be configured to provide, to the set of second network devices, second information associated with a coverage state for the coverage region having the common definition. The component 198 may be configured to receive, from the set of second network devices, third information indicative of another coverage state of the set of second network devices. The component 198 may be configured to receive, from the set of second network devices, a second request for a second coverage state change, associated with the coverage region, for the first network device. The component 198 may be configured to receive, from the set of second network devices, a second report of a second issue, associated with the coverage region, for the first network device. The component 198 may be configured to receive, from the set of second network devices, a second set of beams, SSBs, TRPs, and cells, for the set of second network devices, associated with a second respective set of areas that comprise the coverage region. The component 198 may be configured to receive, from the set of second network devices, a second request for a second status report, associated with a second loading or a second resource availability of a second set of areas that comprise the coverage region, for the first network device. The component 198 may be configured to receive, from the set of second network devices, a second status report, associated with a second loading or a second resource availability of a second set of areas that comprise the coverage region, for the first network device. The component 198 may be configured to receive, from the set of second network devices, a second set of areas, that comprise the coverage region, for second paging of a second UE. The component 198 may be configured to receive, from the set of second network devices, a second location or a second most-recent location in the coverage region of a second UE. The component 198 may be configured to receive, from the set of second network devices, a second set of parameters associated with a second set of areas that comprise the coverage region, where the second set of parameters include at least one of a second mobility threshold or a second priority. The component 198 may be configured to receive, from the set of second network devices, a second set of energy costs for the set of second network devices. The component 198 may be configured to receive, from the set of second network devices, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. The component 198 may be configured to receive, from the set of second network devices: a second expected density, a second average density, a second number, a second expected distribution, or a second expected percentage of second idle or inactive UEs for a second set of areas that comprise the coverage region, for a second set of cells, or for a second set of beams. The component 198 may be configured to receive, from the set of second network devices: a second average, a second minimum, or a second maximum of a second signal strength or a second signal quality, in second uplink or downlink signaling, for the second set of areas, for the second set of cells, or for the second set of beams. The component 198 may be further configured to perform any of the aspects described in connection with the flowchart in FIG. 11, and/or any of the aspects performed by a first network device for any of FIGS. 4-10. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving or retrieving first information indicative of a coverage region, where the coverage region has a common definition common for both the first network device and a set of second network devices. In one configuration, the apparatus 1204, and in particular the cellular baseband processor(s) 1224 and/or the application processor(s) 1206, may include means for providing, to the set of second network devices, second information associated with a coverage state for the coverage region having the common definition. In one configuration, the apparatus 1204, and in particular the cellular baseband processor(s) 1224 and/or the application processor(s) 1206, may include means for receiving, from the set of second network devices, third information indicative of another coverage state of the set of second network devices. In one configuration, the apparatus 1204, and in particular the cellular baseband processor(s) 1224 and/or the application processor(s) 1206, may include means for receiving, from the set of second network devices, a second request for a second coverage state change, associated with the coverage region, for the first network device. In one configuration, the apparatus 1204, and in particular the cellular baseband processor(s) 1224 and/or the application processor(s) 1206, may include means for receiving, from the set of second network devices, a second report of a second issue, associated with the coverage region, for the first network device. In one configuration, the apparatus 1204, and in particular the cellular baseband processor(s) 1224 and/or the application processor(s) 1206, may include means for receiving, from the set of second network devices, a second set of beams, SSBs, TRPs, and cells, for the set of second network devices, associated with a second respective set of areas that comprise the coverage region. In one configuration, the apparatus 1204, and in particular the cellular baseband processor(s) 1224 and/or the application processor(s) 1206, may include means for receiving, from the set of second network devices, a second request for a second status report, associated with a second loading or a second resource availability of a second set of areas that comprise the coverage region, for the first network device. In one configuration, the apparatus 1204, and in particular the cellular baseband processor(s) 1224 and/or the application processor(s) 1206, may include means for receiving, from the set of second network devices, a second status report, associated with a second loading or a second resource availability of a second set of areas that comprise the coverage region, for the first network device. In one configuration, the apparatus 1204, and in particular the cellular baseband processor(s) 1224 and/or the application processor(s) 1206, may include means for receiving, from the set of second network devices, a second set of areas, that comprise the coverage region, for second paging of a second UE. In one configuration, the apparatus 1204, and in particular the cellular baseband processor(s) 1224 and/or the application processor(s) 1206, may include means for receiving, from the set of second network devices, a second location or a second most-recent location in the coverage region of a second UE. In one configuration, the apparatus 1204, and in particular the cellular baseband processor(s) 1224 and/or the application processor(s) 1206, may include means for receiving, from the set of second network devices, a second set of parameters associated with a second set of areas that comprise the coverage region, where the second set of parameters include at least one of a second mobility threshold or a second priority. In one configuration, the apparatus 1204, and in particular the cellular baseband processor(s) 1224 and/or the application processor(s) 1206, may include means for receiving, from the set of second network devices, a second set of energy costs for the set of second network devices. In one configuration, the apparatus 1204, and in particular the cellular baseband processor(s) 1224 and/or the application processor(s) 1206, may include means for receiving, from the set of second network devices, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. In one configuration, the apparatus 1204, and in particular the cellular baseband processor(s) 1224 and/or the application processor(s) 1206, may include means for receiving, from the set of second network devices: a second expected density, a second average density, a second number, a second expected distribution, or a second expected percentage of second idle or inactive UEs for a second set of areas that comprise the coverage region, for a second set of cells, or for a second set of beams. In one configuration, the apparatus 1204, and in particular the cellular baseband processor(s) 1224 and/or the application processor(s) 1206, may include means for receiving, from the set of second network devices: a second average, a second minimum, or a second maximum of a second signal strength or a second signal quality, in second uplink or downlink signaling, for the second set of areas, for the second set of cells, or for the second set of beams. The means may be the component 198 of the apparatus 1204 configured to perform the functions recited by the means. As discussed supra, the component 199 may be configured to provide first information indicative of a coverage region, where the coverage region has a common definition common for both the first network device and a set of second network devices. The component 199 may be configured to receive, from the first network device, second information associated with a coverage state for the coverage region having the common definition. The component 199 may be configured to provide, for the first network device, third information indicative of another coverage state of the set of second network devices. The component 199 may be configured to provide, for the first network device, a second request for a second coverage state change, associated with the coverage region, for the first network device. The component 199 may be configured to provide, for the first network device, a second report of a second issue, associated with the coverage region, for the first network device. The component 199 may be configured to provide, for the first network device, a second set of beams, SSBs, TRPs, and cells, for the set of second network devices, associated with a second respective set of areas that comprise the coverage region. The component 199 may be configured to provide, for the first network device, a second request for a second status report, associated with a second loading or a second resource availability of a second set of areas that comprise the coverage region, for the first network device. The component 199 may be configured to provide, for the first network device, a second status report, associated with a second loading or a second resource availability of a second set of areas that comprise the coverage region, for the first network device. The component 199 may be configured to provide, for the first network device, a second set of areas, that comprise the coverage region, for second paging of a second UE. The component 199 may be configured to provide, for the first network device, a second location or a second most-recent location in the coverage region of a second UE. The component 199 may be configured to provide, for the first network device, a second set of parameters associated with a second set of areas that comprise the coverage region, where the second set of parameters include at least one of a second mobility threshold or a second priority. The component 199 may be configured to provide, for the first network device, a second set of energy costs for the set of second network devices. The component 199 may be configured to provide, for the first network device, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. The component 199 may be configured to provide, for the first network device: a second expected density, a second average density, a second number, a second expected distribution, or a second expected percentage of second idle or inactive UEs for a second set of areas that comprise the coverage region, for a second set of cells, or for a second set of beams. The component 199 may be configured to provide, for the first network device: a second average, a second minimum, or a second maximum of a second signal strength or a second signal quality, in second uplink or downlink signaling, for the second set of areas, for the second set of cells, or for the second set of beams. The component 199 may be further configured to perform any of the aspects described in connection with the flowchart in FIG. 11, and/or any of the aspects performed by a set of second network devices for any of FIGS. 4-10. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. In one configuration, the apparatus 1204, and in particular the cellular baseband processor(s) 1224 and/or the application processor(s) 1206, may include means for providing first information indicative of a coverage region, where the coverage region has a common definition common for both the first network device and a set of second network devices. In one configuration, the apparatus 1204, and in particular the cellular baseband processor(s) 1224 and/or the application processor(s) 1206, may include means for receiving, from the first network device, second information associated with a coverage state for the coverage region having the common definition. In one configuration, the apparatus 1204, and in particular the cellular baseband processor(s) 1224 and/or the application processor(s) 1206, may include means for providing, for the first network device, third information indicative of another coverage state of the set of second network devices. In one configuration, the apparatus 1204, and in particular the cellular baseband processor(s) 1224 and/or the application processor(s) 1206, may include means for providing, for the first network device, a second request for a second coverage state change, associated with the coverage region, for the first network device. In one configuration, the apparatus 1204, and in particular the cellular baseband processor(s) 1224 and/or the application processor(s) 1206, may include means for providing, for the first network device, a second report of a second issue, associated with the coverage region, for the first network device. In one configuration, the apparatus 1204, and in particular the cellular baseband processor(s) 1224 and/or the application processor(s) 1206, may include means for providing, for the first network device, a second set of beams, SSBs, TRPs, and cells, for the set of second network devices, associated with a second respective set of areas that comprise the coverage region. In one configuration, the apparatus 1204, and in particular the cellular baseband processor(s) 1224 and/or the application processor(s) 1206, may include means for providing, for the first network device, a second request for a second status report, associated with a second loading or a second resource availability of a second set of areas that comprise the coverage region, for the first network device. In one configuration, the apparatus 1204, and in particular the cellular baseband processor(s) 1224 and/or the application processor(s) 1206, may include means for providing, for the first network device, a second status report, associated with a second loading or a second resource availability of a second set of areas that comprise the coverage region, for the first network device. In one configuration, the apparatus 1204, and in particular the cellular baseband processor(s) 1224 and/or the application processor(s) 1206, may include means for providing, for the first network device, a second set of areas, that comprise the coverage region, for second paging of a second UE. In one configuration, the apparatus 1204, and in particular the cellular baseband processor(s) 1224 and/or the application processor(s) 1206, may include means for providing, for the first network device, a second location or a second most-recent location in the coverage region of a second UE. In one configuration, the apparatus 1204, and in particular the cellular baseband processor(s) 1224 and/or the application processor(s) 1206, may include means for providing, for the first network device, a second set of parameters associated with a second set of areas that comprise the coverage region, where the second set of parameters include at least one of a second mobility threshold or a second priority. In one configuration, the apparatus 1204, and in particular the cellular baseband processor(s) 1224 and/or the application processor(s) 1206, may include means for providing provide, for the first network device, a second set of energy costs for the set of second network devices. In one configuration, the apparatus 1204, and in particular the cellular baseband processor(s) 1224 and/or the application processor(s) 1206, may include means for providing, for the first network device, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. In one configuration, the apparatus 1204, and in particular the cellular baseband processor(s) 1224 and/or the application processor(s) 1206, may include means for providing, for the first network device: a second expected density, a second average density, a second number, a second expected distribution, or a second expected percentage of second idle or inactive UEs for a second set of areas that comprise the coverage region, for a second set of cells, or for a second set of beams. In one configuration, the apparatus 1204, and in particular the cellular baseband processor(s) 1224 and/or the application processor(s) 1206, may include means for providing, for the first network device: a second average, a second minimum, or a second maximum of a second signal strength or a second signal quality, in second uplink or downlink signaling, for the second set of areas, for the second set of cells, or for the second set of beams. The means may be the component 199 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive or retrieve first information indicative of a coverage region, where the coverage region has a common definition common for both the first network device and a set of second network devices. The component 198 may be configured to provide, to the set of second network devices, second information associated with a coverage state for the coverage region having the common definition. The component 198 may be configured to receive, from the set of second network devices, third information indicative of another coverage state of the set of second network devices. The component 198 may be configured to receive, from the set of second network devices, a second request for a second coverage state change, associated with the coverage region, for the first network device. The component 198 may be configured to receive, from the set of second network devices, a second report of a second issue, associated with the coverage region, for the first network device. The component 198 may be configured to receive, from the set of second network devices, a second set of beams, SSBs, TRPs, and cells, for the set of second network devices, associated with a second respective set of areas that comprise the coverage region. The component 198 may be configured to receive, from the set of second network devices, a second request for a second status report, associated with a second loading or a second resource availability of a second set of areas that comprise the coverage region, for the first network device. The component 198 may be configured to receive, from the set of second network devices, a second status report, associated with a second loading or a second resource availability of a second set of areas that comprise the coverage region, for the first network device. The component 198 may be configured to receive, from the set of second network devices, a second set of areas, that comprise the coverage region, for second paging of a second UE. The component 198 may be configured to receive, from the set of second network devices, a second location or a second most-recent location in the coverage region of a second UE. The component 198 may be configured to receive, from the set of second network devices, a second set of parameters associated with a second set of areas that comprise the coverage region, where the second set of parameters include at least one of a second mobility threshold or a second priority. The component 198 may be configured to receive, from the set of second network devices, a second set of energy costs for the set of second network devices. The component 198 may be configured to receive, from the set of second network devices, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. The component 198 may be configured to receive, from the set of second network devices: a second expected density, a second average density, a second number, a second expected distribution, or a second expected percentage of second idle or inactive UEs for a second set of areas that comprise the coverage region, for a second set of cells, or for a second set of beams. The component 198 may be configured to receive, from the set of second network devices: a second average, a second minimum, or a second maximum of a second signal strength or a second signal quality, in second uplink or downlink signaling, for the second set of areas, for the second set of cells, or for the second set of beams. The component 198 may be further configured to perform any of the aspects described in connection with the flowchart in FIG. 11, and/or any of the aspects performed by a first network device for any of FIGS. 4-10. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for receiving or retrieving first information indicative of a coverage region, where the coverage region has a common definition common for both the first network device and a set of second network devices. In one configuration, the network entity 1302 may include means for providing, to the set of second network devices, second information associated with a coverage state for the coverage region having the common definition. In one configuration, the network entity 1302 may include means for receiving, from the set of second network devices, third information indicative of another coverage state of the set of second network devices. In one configuration, the network entity 1302 may include means for receiving, from the set of second network devices, a second request for a second coverage state change, associated with the coverage region, for the first network device. In one configuration, the network entity 1302 may include means for receiving, from the set of second network devices, a second report of a second issue, associated with the coverage region, for the first network device. In one configuration, the network entity 1302 may include means for receiving, from the set of second network devices, a second set of beams, SSBs, TRPs, and cells, for the set of second network devices, associated with a second respective set of areas that comprise the coverage region. In one configuration, the network entity 1302 may include means for receiving, from the set of second network devices, a second request for a second status report, associated with a second loading or a second resource availability of a second set of areas that comprise the coverage region, for the first network device. In one configuration, the network entity 1302 may include means for receiving, from the set of second network devices, a second status report, associated with a second loading or a second resource availability of a second set of areas that comprise the coverage region, for the first network device. In one configuration, the network entity 1302 may include means for receiving, from the set of second network devices, a second set of areas, that comprise the coverage region, for second paging of a second UE. In one configuration, the network entity 1302 may include means for receiving, from the set of second network devices, a second location or a second most-recent location in the coverage region of a second UE. In one configuration, the network entity 1302 may include means for receiving, from the set of second network devices, a second set of parameters associated with a second set of areas that comprise the coverage region, where the second set of parameters include at least one of a second mobility threshold or a second priority. In one configuration, the network entity 1302 may include means for receiving, from the set of second network devices, a second set of energy costs for the set of second network devices. In one configuration, the network entity 1302 may include means for receiving, from the set of second network devices, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. In one configuration, the network entity 1302 may include means for receiving, from the set of second network devices: a second expected density, a second average density, a second number, a second expected distribution, or a second expected percentage of second idle or inactive UEs for a second set of areas that comprise the coverage region, for a second set of cells, or for a second set of beams. In one configuration, the network entity 1302 may include means for receiving, from the set of second network devices: a second average, a second minimum, or a second maximum of a second signal strength or a second signal quality, in second uplink or downlink signaling, for the second set of areas, for the second set of cells, or for the second set of beams. The means may be the component 198 of the network entity 1302 configured to perform the functions recited by the means. As discussed supra, the component 199 may be configured to provide first information indicative of a coverage region, where the coverage region has a common definition common for both the first network device and a set of second network devices. The component 199 may be configured to receive, from the first network device, second information associated with a coverage state for the coverage region having the common definition. The component 199 may be configured to provide, for the first network device, third information indicative of another coverage state of the set of second network devices. The component 199 may be configured to provide, for the first network device, a second request for a second coverage state change, associated with the coverage region, for the first network device. The component 199 may be configured to provide, for the first network device, a second report of a second issue, associated with the coverage region, for the first network device. The component 199 may be configured to provide, for the first network device, a second set of beams, SSBs, TRPs, and cells, for the set of second network devices, associated with a second respective set of areas that comprise the coverage region. The component 199 may be configured to provide, for the first network device, a second request for a second status report, associated with a second loading or a second resource availability of a second set of areas that comprise the coverage region, for the first network device. The component 199 may be configured to provide, for the first network device, a second status report, associated with a second loading or a second resource availability of a second set of areas that comprise the coverage region, for the first network device. The component 199 may be configured to provide, for the first network device, a second set of areas, that comprise the coverage region, for second paging of a second UE. The component 199 may be configured to provide, for the first network device, a second location or a second most-recent location in the coverage region of a second UE. The component 199 may be configured to provide, for the first network device, a second set of parameters associated with a second set of areas that comprise the coverage region, where the second set of parameters include at least one of a second mobility threshold or a second priority. The component 199 may be configured to provide, for the first network device, a second set of energy costs for the set of second network devices. The component 199 may be configured to provide, for the first network device, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. The component 199 may be configured to provide, for the first network device: a second expected density, a second average density, a second number, a second expected distribution, or a second expected percentage of second idle or inactive UEs for a second set of areas that comprise the coverage region, for a second set of cells, or for a second set of beams. The component 199 may be configured to provide, for the first network device: a second average, a second minimum, or a second maximum of a second signal strength or a second signal quality, in second uplink or downlink signaling, for the second set of areas, for the second set of cells, or for the second set of beams. The component 199 may be further configured to perform any of the aspects described in connection with the flowchart in FIG. 11, and/or any of the aspects performed by a set of second network devices for any of FIGS. 4-10. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. In one configuration, the network entity 1302 may include means for providing first information indicative of a coverage region, where the coverage region has a common definition common for both the first network device and a set of second network devices. In one configuration, the network entity 1302 may include means for receiving, from the first network device, second information associated with a coverage state for the coverage region having the common definition. In one configuration, the network entity 1302 may include means for providing, for the first network device, third information indicative of another coverage state of the set of second network devices. In one configuration, the network entity 1302 may include means for providing, for the first network device, a second request for a second coverage state change, associated with the coverage region, for the first network device. In one configuration, the network entity 1302 may include means for providing, for the first network device, a second report of a second issue, associated with the coverage region, for the first network device. In one configuration, the network entity 1302 may include means for providing, for the first network device, a second set of beams, SSBs, TRPs, and cells, for the set of second network devices, associated with a second respective set of areas that comprise the coverage region. In one configuration, the network entity 1302 may include means for providing, for the first network device, a second request for a second status report, associated with a second loading or a second resource availability of a second set of areas that comprise the coverage region, for the first network device. In one configuration, the network entity 1302 may include means for providing, for the first network device, a second status report, associated with a second loading or a second resource availability of a second set of areas that comprise the coverage region, for the first network device. In one configuration, the network entity 1302 may include means for providing, for the first network device, a second set of areas, that comprise the coverage region, for second paging of a second UE. In one configuration, the network entity 1302 may include means for providing, for the first network device, a second location or a second most-recent location in the coverage region of a second UE. In one configuration, the network entity 1302 may include means for providing, for the first network device, a second set of parameters associated with a second set of areas that comprise the coverage region, where the second set of parameters include at least one of a second mobility threshold or a second priority. In one configuration, the network entity 1302 may include means for providing provide, for the first network device, a second set of energy costs for the set of second network devices. In one configuration, the network entity 1302 may include means for providing, for the first network device, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. In one configuration, the network entity 1302 may include means for providing, for the first network device: a second expected density, a second average density, a second number, a second expected distribution, or a second expected percentage of second idle or inactive UEs for a second set of areas that comprise the coverage region, for a second set of cells, or for a second set of beams. In one configuration, the network entity 1302 may include means for providing, for the first network device: a second average, a second minimum, or a second maximum of a second signal strength or a second signal quality, in second uplink or downlink signaling, for the second set of areas, for the second set of cells, or for the second set of beams. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

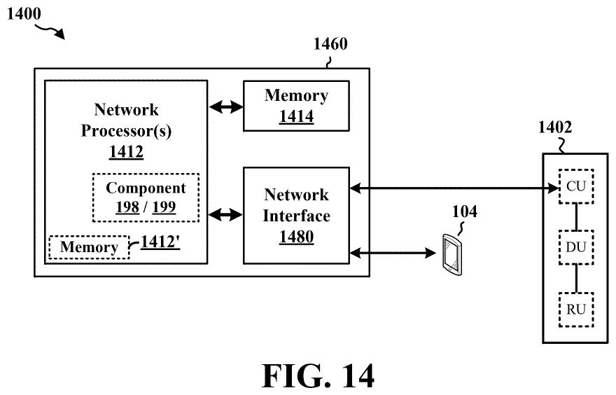

FIG. 14 is a diagram 1400 illustrating an example of a hardware implementation for a network entity 1460. In one example, the network entity 1460 may be within the core network 120. The network entity 1460 may include at least one network processor 1412. The network processor(s) 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402 and/or the UE 104. The on-chip memory 1412′ and the additional memory modules 1414 may each be considered a computer-readable medium/memory. Each computer-readable medium/memory may be non-transitory. The network processor(s) 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive or retrieve first information indicative of a coverage region, where the coverage region has a common definition common for both the first network device and a set of second network devices. The component 198 may be configured to provide, to the set of second network devices, second information associated with a coverage state for the coverage region having the common definition. The component 198 may be configured to receive, from the set of second network devices, third information indicative of another coverage state of the set of second network devices. The component 198 may be configured to receive, from the set of second network devices, a second request for a second coverage state change, associated with the coverage region, for the first network device. The component 198 may be configured to receive, from the set of second network devices, a second report of a second issue, associated with the coverage region, for the first network device. The component 198 may be configured to receive, from the set of second network devices, a second set of beams, SSBs, TRPs, and cells, for the set of second network devices, associated with a second respective set of areas that comprise the coverage region. The component 198 may be configured to receive, from the set of second network devices, a second request for a second status report, associated with a second loading or a second resource availability of a second set of areas that comprise the coverage region, for the first network device. The component 198 may be configured to receive, from the set of second network devices, a second status report, associated with a second loading or a second resource availability of a second set of areas that comprise the coverage region, for the first network device. The component 198 may be configured to receive, from the set of second network devices, a second set of areas, that comprise the coverage region, for second paging of a second UE. The component 198 may be configured to receive, from the set of second network devices, a second location or a second most-recent location in the coverage region of a second UE. The component 198 may be configured to receive, from the set of second network devices, a second set of parameters associated with a second set of areas that comprise the coverage region, where the second set of parameters include at least one of a second mobility threshold or a second priority. The component 198 may be configured to receive, from the set of second network devices, a second set of energy costs for the set of second network devices. The component 198 may be configured to receive, from the set of second network devices, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. The component 198 may be configured to receive, from the set of second network devices: a second expected density, a second average density, a second number, a second expected distribution, or a second expected percentage of second idle or inactive UEs for a second set of areas that comprise the coverage region, for a second set of cells, or for a second set of beams. The component 198 may be configured to receive, from the set of second network devices: a second average, a second minimum, or a second maximum of a second signal strength or a second signal quality, in second uplink or downlink signaling, for the second set of areas, for the second set of cells, or for the second set of beams. The component 198 may be further configured to perform any of the aspects described in connection with the flowchart in FIG. 11, and/or any of the aspects performed by a first network device for any of FIGS. 4-10. The component 198 may be within the network processor(s) 1412. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1460 may include a variety of components configured for various functions. In one configuration, the network entity 1460 may include means for receiving or retrieving first information indicative of a coverage region, where the coverage region has a common definition common for both the first network device and a set of second network devices. In one configuration, the network entity 1460 may include means for providing, to the set of second network devices, second information associated with a coverage state for the coverage region having the common definition. In one configuration, the network entity 1460 may include means for receiving, from the set of second network devices, third information indicative of another coverage state of the set of second network devices. In one configuration, the network entity 1460 may include means for receiving, from the set of second network devices, a second request for a second coverage state change, associated with the coverage region, for the first network device. In one configuration, the network entity 1460 may include means for receiving, from the set of second network devices, a second report of a second issue, associated with the coverage region, for the first network device. In one configuration, the network entity 1460 may include means for receiving, from the set of second network devices, a second set of beams, SSBs, TRPs, and cells, for the set of second network devices, associated with a second respective set of areas that comprise the coverage region. In one configuration, the network entity 1460 may include means for receiving, from the set of second network devices, a second request for a second status report, associated with a second loading or a second resource availability of a second set of areas that comprise the coverage region, for the first network device. In one configuration, the network entity 1460 may include means for receiving, from the set of second network devices, a second status report, associated with a second loading or a second resource availability of a second set of areas that comprise the coverage region, for the first network device. In one configuration, the network entity 1460 may include means for receiving, from the set of second network devices, a second set of areas, that comprise the coverage region, for second paging of a second UE. In one configuration, the network entity 1460 may include means for receiving, from the set of second network devices, a second location or a second most-recent location in the coverage region of a second UE. In one configuration, the network entity 1460 may include means for receiving, from the set of second network devices, a second set of parameters associated with a second set of areas that comprise the coverage region, where the second set of parameters include at least one of a second mobility threshold or a second priority. In one configuration, the network entity 1460 may include means for receiving, from the set of second network devices, a second set of energy costs for the set of second network devices. In one configuration, the network entity 1460 may include means for receiving, from the set of second network devices, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. In one configuration, the network entity 1460 may include means for receiving, from the set of second network devices: a second expected density, a second average density, a second number, a second expected distribution, or a second expected percentage of second idle or inactive UEs for a second set of areas that comprise the coverage region, for a second set of cells, or for a second set of beams. In one configuration, the network entity 1460 may include means for receiving, from the set of second network devices: a second average, a second minimum, or a second maximum of a second signal strength or a second signal quality, in second uplink or downlink signaling, for the second set of areas, for the second set of cells, or for the second set of beams. The means may be the component 198 of the network entity 1460 configured to perform the functions recited by the means. As discussed supra, the component 199 may be configured to provide first information indicative of a coverage region, where the coverage region has a common definition common for both the first network device and a set of second network devices. The component 199 may be configured to receive, from the first network device, second information associated with a coverage state for the coverage region having the common definition. The component 199 may be configured to provide, for the first network device, third information indicative of another coverage state of the set of second network devices. The component 199 may be configured to provide, for the first network device, a second request for a second coverage state change, associated with the coverage region, for the first network device. The component 199 may be configured to provide, for the first network device, a second report of a second issue, associated with the coverage region, for the first network device. The component 199 may be configured to provide, for the first network device, a second set of beams, SSBs, TRPs, and cells, for the set of second network devices, associated with a second respective set of areas that comprise the coverage region. The component 199 may be configured to provide, for the first network device, a second request for a second status report, associated with a second loading or a second resource availability of a second set of areas that comprise the coverage region, for the first network device. The component 199 may be configured to provide, for the first network device, a second status report, associated with a second loading or a second resource availability of a second set of areas that comprise the coverage region, for the first network device. The component 199 may be configured to provide, for the first network device, a second set of areas, that comprise the coverage region, for second paging of a second UE. The component 199 may be configured to provide, for the first network device, a second location or a second most-recent location in the coverage region of a second UE. The component 199 may be configured to provide, for the first network device, a second set of parameters associated with a second set of areas that comprise the coverage region, where the second set of parameters include at least one of a second mobility threshold or a second priority. The component 199 may be configured to provide, for the first network device, a second set of energy costs for the set of second network devices. The component 199 may be configured to provide, for the first network device, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. The component 199 may be configured to provide, for the first network device: a second expected density, a second average density, a second number, a second expected distribution, or a second expected percentage of second idle or inactive UEs for a second set of areas that comprise the coverage region, for a second set of cells, or for a second set of beams. The component 199 may be configured to provide, for the first network device: a second average, a second minimum, or a second maximum of a second signal strength or a second signal quality, in second uplink or downlink signaling, for the second set of areas, for the second set of cells, or for the second set of beams. The component 199 may be further configured to perform any of the aspects described in connection with the flowchart in FIG. 11, and/or any of the aspects performed by a set of second network devices for any of FIGS. 4-10. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. In one configuration, the network entity 1460 may include means for providing first information indicative of a coverage region, where the coverage region has a common definition common for both the first network device and a set of second network devices. In one configuration, the network entity 1460 may include means for receiving, from the first network device, second information associated with a coverage state for the coverage region having the common definition. In one configuration, the network entity 1460 may include means for providing, for the first network device, third information indicative of another coverage state of the set of second network devices. In one configuration, the network entity 1460 may include means for providing, for the first network device, a second request for a second coverage state change, associated with the coverage region, for the first network device. In one configuration, the network entity 1460 may include means for providing, for the first network device, a second report of a second issue, associated with the coverage region, for the first network device. In one configuration, the network entity 1460 may include means for providing, for the first network device, a second set of beams, SSBs, TRPs, and cells, for the set of second network devices, associated with a second respective set of areas that comprise the coverage region. In one configuration, the network entity 1460 may include means for providing, for the first network device, a second request for a second status report, associated with a second loading or a second resource availability of a second set of areas that comprise the coverage region, for the first network device. In one configuration, the network entity 1460 may include means for providing, for the first network device, a second status report, associated with a second loading or a second resource availability of a second set of areas that comprise the coverage region, for the first network device. In one configuration, the network entity 1460 may include means for providing, for the first network device, a second set of areas, that comprise the coverage region, for second paging of a second UE. In one configuration, the network entity 1460 may include means for providing, for the first network device, a second location or a second most-recent location in the coverage region of a second UE. In one configuration, the network entity 1460 may include means for providing, for the first network device, a second set of parameters associated with a second set of areas that comprise the coverage region, where the second set of parameters include at least one of a second mobility threshold or a second priority. In one configuration, the network entity 1460 may include means for providing provide, for the first network device, a second set of energy costs for the set of second network devices. In one configuration, the network entity 1460 may include means for providing, for the first network device, a second set of replacement beam identifiers associated with a second set of areas that comprise the coverage region, where the second set of replacement beam identifiers is indicative of a second set of replacement beams as a second replacement for at least a second portion of a second set of active beams associated with the second set of areas. In one configuration, the network entity 1460 may include means for providing, for the first network device: a second expected density, a second average density, a second number, a second expected distribution, or a second expected percentage of second idle or inactive UEs for a second set of areas that comprise the coverage region, for a second set of cells, or for a second set of beams. In one configuration, the network entity 1460 may include means for providing, for the first network device: a second average, a second minimum, or a second maximum of a second signal strength or a second signal quality, in second uplink or downlink signaling, for the second set of areas, for the second set of cells, or for the second set of beams. The means may be the component 199 of the network entity 1460 configured to perform the functions recited by the means.

Wireless communication networks may support communications between network nodes (e.g., base stations, gNBs, etc.), network entities/functions (e.g., in a core network), and UEs. For instance, network nodes may communicate information between with each other for coverage configurations/reconfigurations, such as information associated with cells and/or beams of such cells, abstract coverage state values, etc. Such communication enables the network nodes to change their coverage states in an informed manner. In such scenarios, a network node may be assumed to keep a history of measurements and/or configuration settings for coverage of another network node and to utilize such information for future operations, such as requesting cell/beam activations from the other network node. In some scenarios, a network node may adopt within or change into different coverage configuration based on different requirements, such as current load, capacity etc. Such configurations may include inactive or different active states based on demand, and may attempt to utilize the configuration changes for improved energy efficiency, network energy savings, improved coverage (e.g., QoS), mobility robustness management, etc. For example, a network node that has changed its configuration may share a node configuration update message that includes impacted cell identifiers, their coverage state indicators, impacted SSB indices, and/or corresponding coverage state indicators (e.g., as mapped into integers defining inactive and different active states). In a related context, there are also procedures for exchanging cell and beam activation requests across network nodes. Aspects presented herein provide frameworks to determine and indicate coverage in a more efficient manner. As an example, without the coordination presented herein, a first network node at time T1 may have had a first coverage configuration and may have notified a second network node about its set of active cells and beams, as well as associated coverage states (e.g., where the coverage state is a 4-bit or 6-bit logical index). The first network node, at time T2, may have changed to a second coverage state configuration (e.g., and again notified the second network node about its updated set of active cells and beams, and associated coverage states). In some cases, for energy savings, the second network node may have deactivated some of its cells and/or beams. At time T3, the second network node may determine it has load issue in a part of its coverage region (e.g., due to the adopted second coverage configuration of the first network node), and may request the first network node to activate some of its cells and beams (e.g., SSBs). Yet, for this to interaction to be utilized, the second network node should have stored/remembered which cells and SSBs of the first network node, at an earlier time (e.g., at T1), were helping with load balancing for that part of its coverage region, and use those cells and beams of the first network node as a reference for making its requests. Such operations are complicated for network nodes to keep such a memory and analysis of mapping between configuration (e.g., cells/beams) of other network nodes and a network node's own coverage regions. Moreover, the first network node may change its beamforming codebook used for its SSBs, but using an SSB index (such as when it is deactivated and no longer available) to refer to a coverage region generally does not properly work.

Aspects herein for dynamic coverage optimization for NES provide improvements that address the issues noted above. For example, network devices may be configured with a coverage region(s) having a common definition that is common therebetween and defined independently of beams, SSBs, TRPs, and cells of network devices, a given coverage region may be made up of a number of areas, associated with unique area identifiers, configured as a set of physical areas, a set of geographic areas, and/or a set of digital area representations, coverage states may be provided for a coverage region and/or for one or more coverage areas and may be indicated based on coverage state indices (e.g., a set of common logical indices), and a coverage indication framework may be utilized between network devices to facilitate communication of coverage state information based on the common coverage region/areas.

Accordingly, aspects herein increase coverage efficiency with the coverage regions by utilizing commonly-/globally-defined coverage regions or zones for network devices, rather than device-specific references (e.g., such as beams/SSBs, cells, and/or the like) to define coverage, and aspects herein also improve communications associated with the configurations/reconfigurations for the coverage regions by utilizing a coverage indication framework based on the commonly-defined coverage regions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network device, comprising: receiving or retrieving first information indicative of a coverage region, wherein the coverage region has a common definition common for both the first network device and a set of second network devices; and providing, to the set of second network devices, second information associated with a coverage state for the coverage region having the common definition.

Aspect 2 is the method of aspect 1, wherein receiving or retrieving the first information includes at least one of: receiving from the set of second network devices, or retrieving based on a prior configuration of the first network device, a configuration or an update associated with at least one of the coverage region or the second information associated with the coverage state for the coverage region; or wherein the common definition is defined independently of beams, synchronization signal blocks (SSBs), transmission reception points (TRPs), and cells of the set of second network devices.

Aspect 3 is the method of any of aspects 1 and 2, wherein the coverage region is based on a set of areas comprising at least one of a set of physical areas, a set of geographic areas, or a set of digital area representations, wherein each area of the set of areas is associated with a unique area identifier.

Aspect 4 is the method of aspect 3, wherein the set of areas is based on at least one of geographic coordinates, a set of references to wireless device identifiers, regular geometries, or irregular geometries; or wherein the coverage state for the coverage region comprises a set of coverage states for each area of the set of areas.

Aspect 5 is the method of aspect 4, wherein a respective common logical index of a set of common logical indices comprised in the second information is indicative of each coverage state of the set of coverage states.

Aspect 6 is the method of any of aspects 1 to 5, wherein the second information includes an indication of the coverage state as a set of coverage states for the first network device over a set of areas that comprise the coverage region, wherein each coverage state of the set of coverage states is (i) associated with a configured quality of service (QoS) for areas of the set of areas and is (ii) indicative of an activated state, a deactivated state, a partially activated state, or a partially deactivated state; or wherein the method further comprises: receiving, from the set of second network devices, third information indicative of another coverage state of the set of second network devices.

Aspect 7 is the method of any of aspects 1 to 6, wherein a request for a coverage state change is indicative of an activation, a deactivation, or another configuration alteration of the coverage state; and wherein the second information comprises a first request for a first coverage state change, associated with the coverage region, for the set of second network devices, or wherein the method further comprises: receiving, from the set of second network devices, a second request for a second coverage state change, associated with the coverage region, for the first network device.

Aspect 8 is the method of any of aspects 1 to 7, wherein the second information is indicative of a first report of a first issue, associated with the coverage region, for the set of second network devices, wherein the first issue is associated with a coverage, a load, or an interference for a set of areas that comprise the coverage region; or wherein the method further comprises: receiving, from the set of second network devices, a second report of a second issue, associated with the coverage region, for the first network device.

Aspect 9 is the method of any of aspects 1 to 8, wherein the second information is indicative of a first set of beams, synchronization signal blocks (SSBs), transmission reception points (TRPs), and cells, for the first network device, associated with a first respective set of areas that comprise the coverage region; or wherein the method further comprises: receiving, from the set of second network devices, a second set of beams, SSBs, TRPs, and cells, for the set of second network devices, associated with a second respective set of areas that comprise the coverage region.

Aspect 10 is the method of any of aspects 1 to 9, wherein the second information is indicative of a first request for a first status report, associated with a first loading or a first resource availability of a first set of areas that comprise the coverage region, for the set of second network devices; or wherein the method further comprises: receiving, from the set of second network devices, a second request for a second status report, associated with a second loading or a second resource availability of a second set of areas that comprise the coverage region, for the first network device.

Aspect 11 is the method of any of aspects 1 to 10, wherein the second information is indicative of a first status report, associated with a first loading or a first resource availability of a first set of areas that comprise the coverage region, for the set of second network devices; or wherein the method further comprises: receiving, from the set of second network devices, a second status report, associated with a second loading or a second resource availability of a second set of areas that comprise the coverage region, for the first network device.

Aspect 12 is the method of any of aspects 1 to 11, wherein the second information is indicative of a first set of areas, that comprise the coverage region, for first paging of a first user equipment (UE); or wherein the method further comprises: receiving, from the set of second network devices, a second set of areas, that comprise the coverage region, for second paging of a second UE.

Aspect 13 is the method of any of aspects 1 to 12, wherein the second information is indicative of a first location or a first most-recent location in the coverage region of a first user equipment (UE); or wherein the method further comprises: receiving, from the set of second network devices, a second location or a second most-recent location in the coverage region of a second UE.

Aspect 14 is the method of any of aspects 1 to 13, wherein the second information is indicative of a first set of parameters associated with a first set of areas that comprise the coverage region, wherein the first set of parameters include at least one of a first mobility threshold or a first priority; or wherein the method further comprises: receiving, from the set of second network devices, a second set of parameters associated with a second set of areas that comprise the coverage region, wherein the second set of parameters include at least one of a second mobility threshold or a second priority.

Aspect 15 is the method of any of aspects 1 to 14, wherein a set of energy costs is associated with a set of areas that comprise the coverage region; and wherein the second information is indicative of a first set of energy costs for the first network device, or wherein the method further comprises: receiving, from the set of second network devices, a second set of energy costs for the set of second network devices.

Aspect 16 is the method of any of aspects 1 to 15, wherein the second information is indicative of a first set of replacement beam identifiers associated with a first set of areas that comprise the coverage region, wherein the first set of replacement beam identifiers is indicative of a first set of replacement beams as a first replacement for at least a first portion of a first set of active beams associated with the first set of areas; or wherein the method further comprises: receiving, from the set of second network devices, a second set of replacement beam identifiers associated with a second set of areas that comprise the coverage region, wherein the second set of replacement beam identifiers is indicative of a second set of replacement beams as a second replacement for at least a second portion of a second set of active beams associated with the second set of areas.

Aspect 17 is the method of any of aspects 1 to 16, wherein the second information is indicative of one or more of a first expected density, a first average density, a first number, a first expected distribution, or a first expected percentage of first idle or inactive user equipments (UEs) for a first set of areas that comprise the coverage region, for a first set of cells, or for a first set of beams, or wherein the second information is indicative of one or more of a first average, a first minimum, or a first maximum of a first signal strength or a first signal quality, in first uplink or downlink signaling, for the first set of areas, for the first set of cells, or for the first set of beams; or wherein the method further comprises: receiving, from the set of second network devices, third information including at least one of: one or more of a second expected density, a second average density, a second number, a second expected distribution, or a second expected percentage of second idle or inactive UEs for a second set of areas that comprise the coverage region, for a second set of cells, or for a second set of beams, or one or more of a second average, a second minimum, or a second maximum of a second signal strength or a second signal quality, in second uplink or downlink signaling, for the second set of areas, for the second set of cells, or for the second set of beams.

Aspect 18 is the method of any of aspects 17, wherein the first network device is a first network node and the set of second network devices comprises a second network node, wherein the first network device is the first network node and the set of second network devices comprises a user equipment (UE), wherein the first network device is the first network node and the set of second network devices comprises a first core network function, or wherein the first network device is a second core network function and the set of second network devices comprises the first core network function; wherein the first network node and the second network node are at least one of a base station, a gNB, a central unit (CU), a distributed unit (DU), or a radio unit (RU), wherein the first core network function and the second core network function are at least one of a location management function (LMF) or an access and mobility management function (AMF).

Aspect 19 is an apparatus for wireless communication at a first network device, comprising: at least one memory; and at least one processor coupled to the at least one memory, the at least one processor, individually or in any combination, is configured to perform the method of any of aspects 1 to 18.

Aspect 20 is an apparatus for wireless communication at a first network device, comprising means for performing each step in the method of any of aspects 1 to 18.

Aspect 21 is the apparatus of any of aspects 19 to 20, further comprising a transceiver configured to receive or to transmit in association with the method of any of aspects 1 to 18.

Aspect 22 is a computer-readable medium (e.g., a non-transitory computer-readable medium) storing computer executable code at a first network device, the code when executed by at least one processor causes the at least one processor to perform the method of any of aspects 1 to 18.

Aspect 23 is a method of wireless communication at a set of second network devices, comprising: providing first information indicative of a coverage region, wherein the coverage region has a common definition common for both a first network device and the set of second network devices; and receiving, from the first network device, second information associated with a coverage state for the coverage region having the common definition.

Aspect 24 is the method of aspect 23, wherein providing the first information includes providing, for the first network device, a configuration or an update associated with at least one of the coverage region or the second information associated with the coverage state for the coverage region; or wherein the common definition is defined independently of beams, synchronization signal blocks (SSBs), transmission reception points (TRPs), and cells of the first network device.

Aspect 25 is the method of any of aspects 23 and 24, wherein the coverage region is based on a set of areas comprising at least one of a set of physical areas, a set of geographic areas, or a set of digital area representations, wherein each area of the set of areas is associated with a unique area identifier.

Aspect 26 is the method of aspect 25, wherein the set of areas is based on at least one of geographic coordinates, a set of references to wireless device identifiers, regular geometries, or irregular geometries; or wherein the coverage state for the coverage region comprises a set of coverage states for each area of the set of areas.

Aspect 27 is the method of aspect 26, wherein a respective common logical index of a set of common logical indices comprised in the second information is indicative of each coverage state of the set of coverage states.

Aspect 28 is the method of any of aspects 23 to 27, wherein the second information includes an indication of the coverage state as a set of coverage states for the set of second network devices over a set of areas that comprise the coverage region, wherein each coverage state of the set of coverage states is (i) associated with a configured quality of service (QoS) for areas of the set of areas and is (ii) indicative of an activated state, a deactivated state, a partially activated state, or a partially deactivated state; or wherein the method further comprises: providing, for the first network device, third information indicative of another coverage state of the first network device.

Aspect 29 is the method of any of aspects 23 to 28, wherein a request for a coverage state change is indicative of an activation, a deactivation, or another configuration alteration of the coverage state; and wherein the second information comprises a first request for a first coverage state change, associated with the coverage region, for the first network device, or wherein the method further comprises: providing, for the first network device, a second request for a second coverage state change, associated with the coverage region, for the set of second network devices.

Aspect 30 is the method of any of aspects 23 to 29, wherein the second information is indicative of a first report of a first issue, associated with the coverage region, for the set of second network devices, wherein the first issue is associated with a coverage, a load, or an interference for a set of areas that comprise the coverage region; or wherein the method further comprises: providing, for the first network device, a second report of a second issue, associated with the coverage region, for the set of second network devices.

Aspect 31 is the method of any of aspects 23 to 30, wherein the second information is indicative of a first set of beams, synchronization signal blocks (SSBs), transmission reception points (TRPs), and cells, for the second set of network devices, associated with a first respective set of areas that comprise the coverage region; or wherein the method further comprises: providing, for the first network device, a second set of beams, SSBs, TRPs, and cells, for the first network device, associated with a second respective set of areas that comprise the coverage region.

Aspect 32 is the method of any of aspects 23 to 31, wherein the second information is indicative of a first request for a first status report, associated with a first loading or a first resource availability of a first set of areas that comprise the coverage region, for the first network device; or wherein the method further comprises: providing, for the first network device, a second request for a second status report, associated with a second loading or a second resource availability of a second set of areas that comprise the coverage region, for the set of second network devices.

Aspect 33 is the method of any of aspects 23 to 32, wherein the second information is indicative of a first status report, associated with a first loading or a first resource availability of a first set of areas that comprise the coverage region, for the first network device; or wherein the method further comprises: providing, for the first network device, a second status report, associated with a second loading or a second resource availability of a second set of areas that comprise the coverage region, for the set of second network devices.

Aspect 34 is the method of any of aspects 23 to 33, wherein the second information is indicative of a first set of areas, that comprise the coverage region, for first paging of a first user equipment (UE); or wherein the method further comprises: providing, for the first network device, a second set of areas, that comprise the coverage region, for second paging of a second UE.

Aspect 35 is the method of any of aspects 23 to 34, wherein the second information is indicative of a first location or a first most-recent location in the coverage region of a first user equipment (UE); or wherein the method further comprises: providing, for the first network device, a second location or a second most-recent location in the coverage region of a second UE.

Aspect 36 is the method of any of aspects 23 to 35, wherein the second information is indicative of a first set of parameters associated with a first set of areas that comprise the coverage region, wherein the first set of parameters include at least one of a first mobility threshold or a first priority; or wherein the method further comprises: providing, for the first network device, a second set of parameters associated with a second set of areas that comprise the coverage region, wherein the second set of parameters include at least one of a second mobility threshold or a second priority.

Aspect 37 is the method of any of aspects 23 to 36, wherein a set of energy costs is associated with a set of areas that comprise the coverage region; and wherein the second information is indicative of a first set of energy costs for the set of second network devices, or wherein the method further comprises: providing, for the first network device, a second set of energy costs for the first network device.

Aspect 38 is the method of any of aspects 23 to 37, wherein the second information is indicative of a first set of replacement beam identifiers associated with a first set of areas that comprise the coverage region, wherein the first set of replacement beam identifiers is indicative of a first set of replacement beams as a first replacement for at least a first portion of a first set of active beams associated with the first set of areas; or wherein the method further comprises: providing, for the first network device, a second set of replacement beam identifiers associated with a second set of areas that comprise the coverage region, wherein the second set of replacement beam identifiers is indicative of a second set of replacement beams as a second replacement for at least a second portion of a second set of active beams associated with the second set of areas.

Aspect 39 is the method of any of aspects 23 to 38, wherein the second information is indicative of one or more of a first expected density, a first average density, a first number, a first expected distribution, or a first expected percentage of first idle or inactive user equipments (UEs) for a first set of areas that comprise the coverage region, for a first set of cells, or for a first set of beams, or wherein the second information is indicative of one or more of a first average, a first minimum, or a first maximum of a first signal strength or a first signal quality, in first uplink or downlink signaling, for the first set of areas, for the first set of cells, or for the first set of beams; or wherein the method further comprises: providing, for the first network device, third information including at least one of: one or more of a second expected density, a second average density, a second number, a second expected distribution, or a second expected percentage of second idle or inactive UEs for a second set of areas that comprise the coverage region, for a second set of cells, or for a second set of beams, or one or more of a second average, a second minimum, or a second maximum of a second signal strength or a second signal quality, in second uplink or downlink signaling, for the second set of areas, for the second set of cells, or for the second set of beams.

Aspect 40 is the method of any of aspects 23 to 39, wherein the second set of network devices is a first network node and the first network device comprises a second network node, wherein the second set of network devices is the first network node and the first network device comprises a user equipment (UE), wherein the second set of network devices is the first network node and the first network device comprises a first core network function, or wherein the second set of network devices is a second core network function and the first network device comprises the first core network function; wherein the first network node and the second network node are at least one of a base station, a gNB, a central unit (CU), a distributed unit (DU), or a radio unit (RU), wherein the first core network function and the second core network function are at least one of a location management function (LMF) or an access and mobility management function (AMF).

Aspect 41 is an apparatus for wireless communication at a set of second network devices, comprising: at least one memory; and at least one processor coupled to the at least one memory, the at least one processor, individually or in any combination, is configured to perform the method of any of aspects 23 to 40.

Aspect 42 is an apparatus for wireless communication at a set of second network devices, comprising means for performing each step in the method of any of aspects 23 to 40.

Aspect 43 is the apparatus of any of aspects 41 to 42, further comprising a transceiver configured to receive or to transmit in association with the method of any of aspects 23 to 40.

Aspect 44 is a computer-readable medium (e.g., a non-transitory computer-readable medium) storing computer executable code at a set of second network devices, the code when executed by at least one processor causes the at least one processor to perform the method of any of aspects 23 to 40.

What is claimed is:

1. An apparatus for wireless communication at a first network device, comprising:
at least one memory; and
at least one processor coupled to the at least one memory and, based at least in part on information stored in the at least one memory, the at least one processor, individually or in any combination, is configured to:
receive or retrieve first information indicative of a coverage region, wherein the coverage region has a common definition common for both the first network device and a set of second network devices; and
provide, to the set of second network devices, second information associated with a coverage state for the coverage region having the common definition.

2. The apparatus of claim 1, wherein to receive or retrieve the first information, the at least one processor, individually or in any combination, is configured to:
receive from the set of second network devices, or retrieve based on a prior configuration of the first network device, a configuration or an update associated with at least one of the coverage region or the second information associated with the coverage state for the coverage region; or
wherein the common definition is defined independently of beams, synchronization signal blocks (SSBs), transmission reception points (TRPs), and cells of the set of second network devices.

3. The apparatus of claim 1, wherein the coverage region is based on a set of areas comprising at least one of a set of physical areas, a set of geographic areas, or a set of digital area representations, wherein each area of the set of areas is associated with a unique area identifier.

4. The apparatus of claim 3, wherein the set of areas is based on at least one of geographic coordinates, a set of references to wireless device identifiers, regular geometries, or irregular geometries; or
wherein the coverage state for the coverage region comprises a set of coverage states for each area of the set of areas.

5. The apparatus of claim 4, wherein a respective common logical index of a set of common logical indices comprised in the second information is indicative of each coverage state of the set of coverage states.

6. The apparatus of claim 1, wherein the second information includes an indication of the coverage state as a set of coverage states for the first network device over a set of areas that comprise the coverage region, wherein each coverage state of the set of coverage states is (i) associated with a configured quality of service (QOS) for areas of the set of areas and is (ii) indicative of an activated state, a deactivated state, a partially activated state, or a partially deactivated state; or
wherein the at least one processor, individually or in any combination, is further configured to:
receive, from the set of second network devices, third information indicative of another coverage state of the set of second network devices.

7. The apparatus of claim 1, wherein a request for a coverage state change is indicative of an activation, a deactivation, or another configuration alteration of the coverage state; and
wherein the second information comprises a first request for a first coverage state change, associated with the coverage region, for the set of second network devices, or
wherein the at least one processor, individually or in any combination, is further configured to:
receive, from the set of second network devices, a second request for a second coverage state change, associated with the coverage region, for the first network device.

8. The apparatus of claim 1, wherein the second information is indicative of a first report of a first issue, associated with the coverage region, for the set of second network devices, wherein the first issue is associated with a coverage, a load, or an interference for a set of areas that comprise the coverage region; or
wherein the at least one processor, individually or in any combination, is further configured to:
receive, from the set of second network devices, a second report of a second issue, associated with the coverage region, for the first network device.

9. The apparatus of claim 1, wherein the second information is indicative of a first set of beams, synchronization signal blocks (SSBs), transmission reception points (TRPs), and cells, for the first network device, associated with a first respective set of areas that comprise the coverage region; or
wherein the at least one processor, individually or in any combination, is further configured to:
receive, from the set of second network devices, a second set of beams, SSBs, TRPs, and cells, for the set of second network devices, associated with a second respective set of areas that comprise the coverage region.

10. The apparatus of claim 1, wherein the second information is indicative of a first request for a first status report, associated with a first loading or a first resource availability of a first set of areas that comprise the coverage region, for the set of second network devices; or
wherein the at least one processor, individually or in any combination, is further configured to:
receive, from the set of second network devices, a second request for a second status report, associated with a second loading or a second resource availability of a second set of areas that comprise the coverage region, for the first network device.

11. The apparatus of claim 1, wherein the second information is indicative of a first status report, associated with a first loading or a first resource availability of a first set of areas that comprise the coverage region, for the set of second network devices; or
wherein the at least one processor, individually or in any combination, is further configured to:
receive, from the set of second network devices, a second status report, associated with a second loading or a second resource availability of a second set of areas that comprise the coverage region, for the first network device.

12. The apparatus of claim 1, wherein the second information is indicative of a first set of areas, that comprise the coverage region, for first paging of a first user equipment (UE); or
wherein the at least one processor, individually or in any combination, is further configured to:
receive, from the set of second network devices, a second set of areas, that comprise the coverage region, for second paging of a second UE.

13. The apparatus of claim 1, wherein the second information is indicative of a first location or a first most-recent location in the coverage region of a first user equipment (UE); or
wherein the at least one processor, individually or in any combination, is further configured to:
receive, from the set of second network devices, a second location or a second most-recent location in the coverage region of a second UE.

14. The apparatus of claim 1, wherein the second information is indicative of a first set of parameters associated with a first set of areas that comprise the coverage region, wherein the first set of parameters include at least one of a first mobility threshold or a first priority; or
wherein the at least one processor, individually or in any combination, is further configured to:
receive, from the set of second network devices, a second set of parameters associated with a second set of areas that comprise the coverage region, wherein the second set of parameters include at least one of a second mobility threshold or a second priority.

15. The apparatus of claim 1, wherein a set of energy costs is associated with a set of areas that comprise the coverage region; and
wherein the second information is indicative of a first set of energy costs for the first network device, or
wherein the at least one processor, individually or in any combination, is further configured to:
receive, from the set of second network devices, a second set of energy costs for the set of second network devices.

16. The apparatus of claim 1, wherein the second information is indicative of a first set of replacement beam identifiers associated with a first set of areas that comprise the coverage region, wherein the first set of replacement beam identifiers is indicative of a first set of replacement beams as a first replacement for at least a first portion of a first set of active beams associated with the first set of areas; or
wherein the apparatus further comprises at least one transceiver coupled to the at least one processor, wherein the at least one processor, individually or in any combination, is further configured to:
receive, from the set of second network devices and via the at least one transceiver, a second set of replacement beam identifiers associated with a second set of areas that comprise the coverage region, wherein the second set of replacement beam identifiers is indicative of a second set of replacement beams as a second replacement for at least a second portion of a second set of active beams associated with the second set of areas.

17. The apparatus of claim 1, wherein the second information is indicative of one or more of a first expected density, a first average density, a first number, a first expected distribution, or a first expected percentage of first idle or inactive user equipments (UEs) for a first set of areas that comprise the coverage region, for a first set of cells, or for a first set of beams, or
wherein the second information is indicative of one or more of a first average, a first minimum, or a first maximum of a first signal strength or a first signal quality, in first uplink or downlink signaling, for the first set of areas, for the first set of cells, or for the first set of beams; or
wherein the at least one processor, individually or in any combination, is further configured to:
receive, from the set of second network devices, third information including at least one of:
one or more of a second expected density, a second average density, a second number, a second expected distribution, or a second expected percentage of second idle or inactive UEs for a second set of areas that comprise the coverage region, for a second set of cells, or for a second set of beams, or
one or more of a second average, a second minimum, or a second maximum of a second signal strength or a second signal quality, in second uplink or downlink signaling, for the second set of areas, for the second set of cells, or for the second set of beams.

18. The apparatus of claim 1, wherein the first network device is a first network node and the set of second network devices comprises a second network node, wherein the first network device is the first network node and the set of second network devices comprises a user equipment (UE), wherein the first network device is the first network node and the set of second network devices comprises a first core network function, or wherein the first network device is a second core network function and the set of second network devices comprises the first core network function;
wherein the first network node and the second network node are at least one of a base station, a gNB, a central unit (CU), a distributed unit (DU), or a radio unit (RU), wherein the first core network function and the second core network function are at least one of a location management function (LMF) or an access and mobility management function (AMF).

19. A method of wireless communication at a first network device, comprising:
receiving or retrieving first information indicative of a coverage region, wherein the coverage region has a common definition common for both the first network device and a set of second network devices; and
providing, to the set of second network devices, second information associated with a coverage state for the coverage region having the common definition.

20. A computer-readable medium storing computer executable code at a first network device, the code when executed by at least one processor causes the at least one processor to:
receive or retrieve first information indicative of a coverage region, wherein the coverage region has a common definition common for both the first network device and a set of second network devices; and
provide, to the set of second network devices, second information associated with a coverage state for the coverage region having the common definition.
